(19) United States
(12) Patent Application Publication
(10) Pub. No.: US 2026/0259659 A1
(43) Pub. Date: Sep. 3, 2026

(54) ELECTRONIC DEVICE AND CONTROL METHOD

(71) Applicant: Lenovo (Beijing) Limited, Beijing (CN)

(72) Inventor: Binqiang MA, Beijing (CN)

(21) Appl. No.: 19/533,000

(22) Filed: Feb. 6, 2026

(30) Foreign Application Priority Data
Feb. 28, 2025 (CN) 202510238126.0

(51) Int. Cl. G06F 3/0487; G06F 1/16; G06F 3/0481

(52) U.S. Cl. CPC G06F 3/0487; G06F 1/1681; G06F 3/0481; G06F 2203/04803

(57) ABSTRACT

A control method includes, in response to a target trigger event, controlling a control area provided at a display screen of an electronic device to be in an enabled state. In the enabled state, the control area is able to respond to a target control operation to control at least one of a display parameter or display content of one or more display areas on the display screen, and the control area abuts at least one of the one or more display areas.

### CROSS-REFERENCE TO RELATED APPLICATION

This application claims priority to Chinese Patent Application No. 202510238126.0, filed on February 28, 2025, the entire content of which is incorporated herein by reference.

### TECHNICAL FIELD

The present disclosure generally relates to the field of electronic technologies, and, more particularly, to an electronic device and a control method.

### BACKGROUND

When it is needed to display different areas on a screen, a software solution primarily involves dragging and dropping different windows, while a hardware solution involves connecting different display devices, such as multi-screen splicing. However, these methods generally suffer from inconvenience in operation and poor partitioned display effects.

### SUMMARY

In accordance with the disclosure, there is provided a control method including, in response to a target trigger event, controlling a control area provided at a display screen of an electronic device to be in an enabled state. In the enabled state, the control area is able to respond to a target control operation to control at least one of a display parameter or display content of one or more display areas on the display screen, and the control area abuts at least one of the one or more display areas.

Also in accordance with the disclosure, there is provided an electronic device including a device body, and a display screen disposed at the device body. The display screen includes one or more display areas, and a control area abutting at least one of the one or more display areas and configured to have an enabled state or a disabled state. In the enabled state, the control area is able to respond to a target control operation to control at least one of a display parameter or display content of at least one of the one or more display areas, and/or in the disabled state, the control area is in a screen-off state, a hidden state, or a prohibited state.

Also in accordance with the disclosure, there is provided a non-transitory computer-readable storage medium storing a computer program that, when executed by a processor of an electronic device, causes the electronic device to, in response to a target trigger event, control a control area provided at a display screen of the electronic device to be in an enabled state. In the enabled state, the control area is able to respond to a target control operation to control at least one of a display parameter or display content of one or more display areas on the display screen, and the control area abuts at least one of the one or more display areas.

### BRIEF DESCRIPTION OF THE DRAWINGS

FIG. 1 is a schematic structural diagram of an electronic device consistent with embodiments of the present disclosure.

FIG. 2 is a schematic display diagram of a display screen consistent with embodiments of the present disclosure.

FIG. 3 is another schematic display diagram of a display screen consistent with embodiments of the present disclosure.

FIG. 4 is another schematic display diagram of a display screen consistent with embodiments of the present disclosure.

FIG. 5 is another schematic display diagram of a display screen consistent with embodiments of the present disclosure.

FIG. 6 is another schematic display diagram of a display screen consistent with embodiments of the present disclosure.

FIG. 7 is another schematic display diagram of a display screen consistent with embodiments of the present disclosure.

FIG. 8 is another schematic display diagram of a display screen consistent with embodiments of the present disclosure.

FIG. 9 is another schematic display diagram of a display screen consistent with embodiments of the present disclosure.

FIG. 11 is another schematic display diagram of a display screen consistent with embodiments of the present disclosure.

FIG. 12 is another schematic display diagram of a display screen consistent with embodiments of the present disclosure.

FIG. 13 is another schematic display diagram of a display screen consistent with embodiments of the present disclosure.

FIG. 14 is another schematic display diagram of a display screen consistent with embodiments of the present disclosure.

FIG. 15 is another schematic structural diagram of an electronic device consistent with embodiments of the present disclosure.

FIG. 16 is another schematic structural diagram of an electronic device consistent with embodiments of the present disclosure.

FIG. 17 is another schematic display diagram of a display screen consistent with embodiments of the present disclosure.

FIG. 18 is another schematic display diagram of a display screen consistent with embodiments of the present disclosure.

FIG. 19 is another schematic structural diagram of an electronic device consistent with embodiments of the present disclosure.

FIG. 20 is a flow chart of a control method consistent with embodiments of the present disclosure.

FIG. 21 is another schematic structural diagram of an electronic device consistent with embodiments of the present disclosure.

FIG. 22 is another schematic structural diagram of an electronic device consistent with embodiments of the present disclosure.

FIG. 23 is another flow chart of a control method consistent with embodiments of the present disclosure.

FIG. 24 is another schematic structural diagram of an electronic device consistent with embodiments of the present disclosure.

FIG. 25 is another schematic structural diagram of an electronic device consistent with embodiments of the present disclosure.

### DETAILED DESCRIPTION OF THE EMBODIMENTS

Various schemes and features of the present disclosure are described herein with reference to the accompanying drawings. The embodiments in the present disclosure are only used to describe the present disclosure and are not intended to limit the scope of the present disclosure. It is understandable that other embodiments obtained by those skilled in the art in the absence of inventive effort are within the scope of the present disclosure.

The description of the electronic device in the present disclosure is similar to that of the embodiments of the control method and has similar beneficial effects. Therefore, it will not be repeated. For technical details not disclosed in the embodiments of the electronic device, reference may be made to the description of the embodiments of the control method in the present disclosure for understanding.

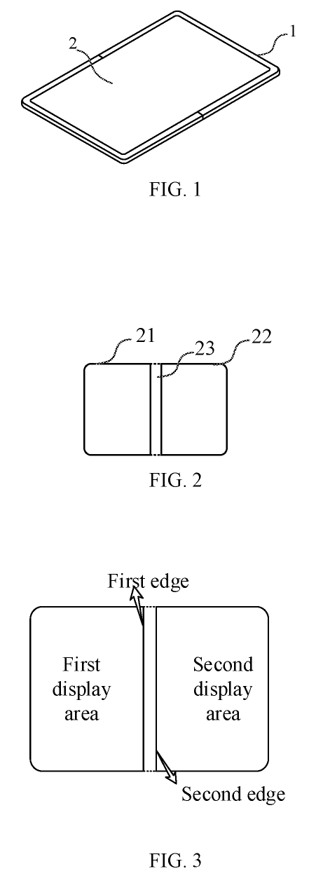

The present disclosure provides an electronic device. In one embodiment, as shown in FIG. 1, the electronic device may include a device body 1 and a display screen 2 disposed at the device body.

In the present disclosure, the electronic device may be any device with communication, storage, and computing functions, such as a tablet, a laptop, a mobile phone, a monitor, an all-in-one computer, a game console, or another electronic apparatus.

In some embodiments, the device body may be a housing that accommodates the display screen. The device body may be a plate-shaped or groove-shaped housing molded as one piece, or a body formed by two or three rotatably connected bodies.

In some embodiments, the display screen may be a flexible screen, a rigid screen, or a combination of a rigid screen and a flexible screen. A flexible screen may be a screen that is able to be bent, rolled, or even folded, and may have the characteristics of being thin and flexible. The rigid screen may be a screen made of rigid materials, and may have the characteristics of structural stability, high screen refresh rate, high transparency, and good color performance.

In one embodiment, the display screen may include at least two display areas and control area(s) disposed outside the at least two display areas. That is, the display screen on the device body may include several display areas, and the number and distribution of the display areas are not specifically limited in the present disclosure. Also, to achieve display control of each display area, the display screen may also include control area(s), and the distribution and number of control area(s) are not specifically limited in the present disclosure.

A display area may represent an area on the display screen capable of displaying or outputting content or images such as images or text.

In some embodiments, one control area may be configured to respond to a target control operation to control the display of at least one of the at least two display areas.

In some embodiments, a target control operation may represent an operation for controlling the display of the at least two display areas. The target control operation may generate control instructions based on controls, interactive gestures, etc., to control the display content, display parameter(s), display mode, display effects, etc., of the at least two display areas. In some other embodiments, the target control operation may also be an input operation (such as dragging, clicking, hovering, etc.) implemented in the control area through an input device of the electronic device (such as a mouse or touchpad).

In some embodiments, the display content may include at least one of: an application window displaying a specific application, a target file, environmental data captured by a camera, a widget plugin, clock data, or a notification message.

In some embodiments, the display parameter(s) may include at least one of: display status parameters, display mode parameters, display brightness parameters, display refresh rate parameters, color theme style parameters, or display area size parameters. The display status parameters may include parameters characterizing the display states of the at least two display areas. For example, the display state may include a display state or a non-display state. The display mode parameters may include parameters characterizing the display modes of the at least two display areas. The present disclosure does not specifically limit the display modes. For example, the display modes may include a standard display mode, an eye protection mode, an outdoor mode, a screen casting mode, or a picture-in-picture mode, etc. The display brightness parameters may include parameters characterizing the brightness of the at least two display areas. The display refresh rate parameters may include parameters characterizing the refresh rate of the at least two display areas. The color theme style parameters may be used to indicate the color information and theme style of the at least two display areas. The present disclosure does not limit the color information. For example, the color information may include color gamut, color depth, or color accuracy, etc. The display area size parameters may be used to indicate the sizes of the at least two display areas.

In the present disclosure, the electronic device, through the control area(s) on the display screen, may control the display of different display areas separately, or control the display of a specific display area (such as an A-side screen area of a laptop computer). This may not only improve the effect of partitioned display but also greatly enhance the convenience of partitioned or split-screen display, thereby improving the intelligence of the electronic device.

In some embodiments, the display screen may include a first display area, a second display area, and a first control area disposed between the first display area and the second display area.

Exemplarily, as shown in FIG. 2, the display screen may include a first display area 21, a second display area 22, and a first control area 23 disposed between the first display area and the second display area.

In some embodiments, the first control area may control the display parameter(s) and/or display content of the first display area and/or the second display area in response to the target control operation.

For example, as shown in FIG. 2, with the first display area, the second display area, and the first control area, assuming the electronic device receives a target control operation at a certain moment for controlling the display contents of the first display area and the second display area, the electronic device may respond to the target control operation by simultaneously controlling the display contents of the first display area and the second display area; and assuming the electronic device receives a target control operation at a certain moment for controlling the display parameter(s) of the first display area, the electronic device may respond to the target control operation by controlling the display parameter(s) of the first display area independently.

In some embodiments, as shown in FIG. 3, the first display area may have a first edge closest to the second display area (i.e., the first edge is closest to the second display area among all edges of the first display area), and the second display area may have a second edge closest to the first display area (i.e., the second edge is closest to the first display area among all edges of the second display area).

In some embodiments, the first edge and the second edge may have the same length in the extending direction, and the control area’s two opposite edges, that are opposite to each other in a direction perpendicular to the extending direction, may coincide with or abut the first edge and the second edge, respectively.

For example, as shown in FIG. 3, the area between the first edge and the second edge may be the control area, and the edges of the control area may coincide with or abut the first edge and the second edge.

In some other embodiments, the first edge may have a different length from the second edge in the extending direction. The first edge may be longer than the second edge in the extending direction, and the control area’s opposite edges, that are opposite to each other in a direction perpendicular to the extending direction, may coincide with or abut the second edge, and coincide with or abut a portion of the first edge relative to the second edge, respectively.

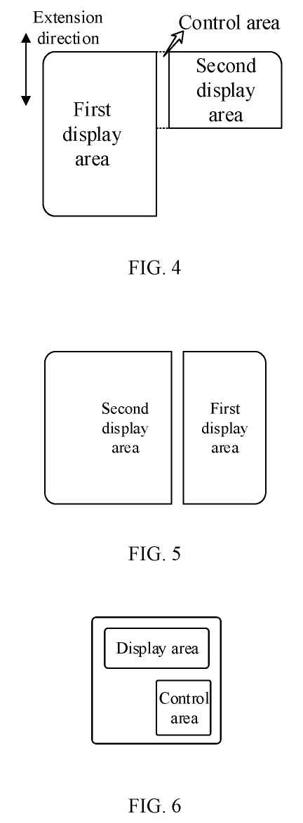

Exemplarily, as shown in FIG. 4, the length of the first edge of the first display area may be longer than the length of the second edge of the second display area in the extending direction, while the control area may be located between the first edge and the second edge. The opposite edges of the control area, that are opposite to each other in a direction perpendicular to the extending direction, may coincide with or abut the second edge, and coincide with or abut a portion of the first edge relative to the second edge, respectively.

In some embodiments, the edges of the display areas and the edges of the control area may not coincide or connect; that is, there may be a gap between the edges of the display areas and the edges of the control area.

In some embodiments, the display sizes of different display areas may be the same or different, and the present disclosure does not specifically limit this. For example, as shown in FIG. 4, in one embodiment, the display sizes of the first display area and the second display area may be different, with the first display area being larger than the second display area. In another embodiment, as shown in FIG. 5, the display size of the first display area may be smaller than the display size of the second display area.

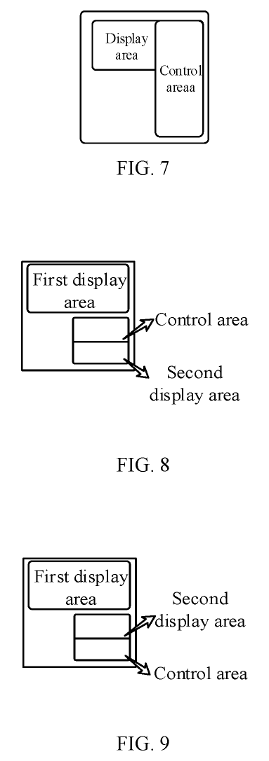

The distribution of the at least two display areas and the control area(s) is not limited in the present disclosure. For example, there may be four distribution manners, such as those shown in FIG. 6 to FIG. 9. As shown in FIG. 6, any display area and the control area may be vertically distributed, with the control area being located below any display area. As shown in FIG. 7, any display area and control area may be horizontally distributed, with the control area being located to the right of any display area. As shown in FIG. 8, the control area may be vertically distributed with two display areas, and the control area may be located between two display areas. In FIG. 9, the control area may be vertically distributed with two display areas, and the control area may be located below the two display areas, such as at the bottom of the display screen.

Exemplarily, as shown in FIG. 10, in one embodiment, the control area may still be located between the two display areas. The edges of the display areas and the edges of the control area may not overlap or connect, but may have a certain gap.

It may be seen that the control area and the at least two display areas in the present disclosure may be flexibly distributed on the display screen in various arrangements, which may meet more practical usage scenarios, to better display the content on the display screen and effectively improve the intelligence of the electronic device.

In some embodiments, the display screen may further include a third display area. The second display area and the third display area may be laid out on one side of the first display area along the extending direction of the first edge of the first display area. A second control area may be disposed between the second display area and the third display area. The second control area may be capable of controlling the display parameter(s) and/or display contents of the second display area and/or the third display area in response to a target control operation. And/or, a third control area may be further disposed between the third display area and the first display area, and the third control area may be capable of controlling the display parameter(s) and/or display content of the third display area and/or the first display area in response to a target control operation. The types and/or numbers of control operations to which the second and third control area(s) may respond may be the same or different.

Exemplarily, as shown in FIG. 11, in another embodiment, a first control area may be disposed between the first display and the second display area, a second control area may be disposed between the second display area and the third display area, and a third control area may be disposed between the first display area and the third display area.

In some embodiments, the types and/or numbers of control operations to which the second control area and the third control area may respond may be different. This may be understood as the second control area and the third control area having different permissions regarding the types and/or numbers of control operations to which they may respond. For example, the types of target control operations to which the second control area may respond may include control operations for display parameter(s) or control operations for display modes, while the type of target control operations to which the third control area may respond may only include control operations for display modes.

In some embodiments, the types and/or numbers of control operations to which each control area in the display screen may respond may be customized.

In some embodiments, a control permission of one control area to which one display area in the display screen may respond may be customized. That is, one display area may respond to the target control operation of one corresponding pre-set control area to complete the corresponding display.

In some embodiments, when both the first control area and the third control area respond to the target control operation to control the display parameter(s) and/or display content of the first display area, one control area that is used to control the display parameter(s) and/or display content of the second display area and the third display area may be determined based on the pre-set control permissions of the second display area and the third display area.

For example, taking the display areas and control area(s) shown in FIG. 11 as an example, when both the first control area and the third control area are used to control the display parameter(s) and/or display content of the first display area, assuming that the preset control permission is that both the second display area and the third display area may be controlled by the second control area, the electronic device may control the display parameter(s) and/or display content of the second display area and the third display area in response to the target control operation of the second control area. Assuming that the preset control permission is that the second display area may be controlled by the second control area and the third display area may be controlled by the third control area, the electronic device may control the display parameter(s) and/or display content of the second display area in response to the target control operation of the second control area, and may control the display parameter(s) and/or display content of the third display area in response to the target control operation of the third control area.

In some embodiments, the display screen may include a fourth display area and a fifth display area with their edges abutting each other, and a fourth control area disposed at or outside a third edge of the fourth display area and the fifth display area, where the third edge is an edge perpendicular to the abutting edge of the fourth display area and the fifth display area.

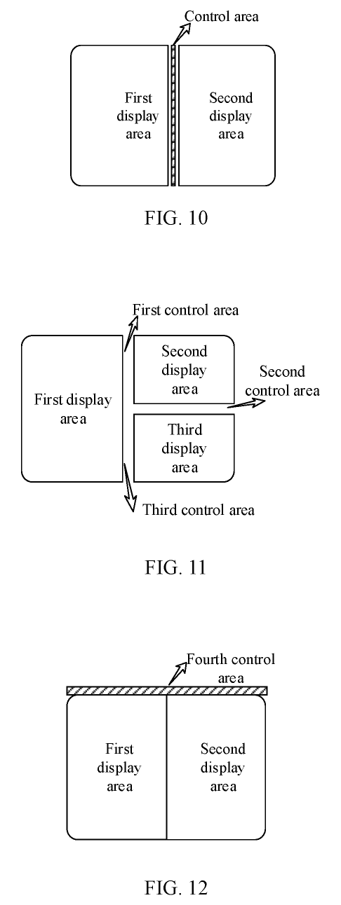

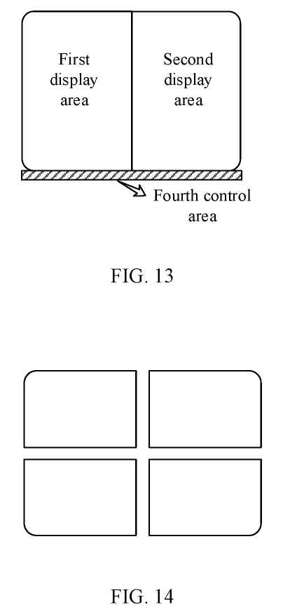

Exemplarily, as shown in FIG. 12, when the third edge is a complete edge at the lower end of the fourth display area and the fifth display area, the fourth control area may be located at the top of the fourth display area and the fifth display area. Or, as shown in FIG. 13, when the third edge is the top edge of the fourth display area and the fifth display area, the fourth control area may be located at the bottom of the fourth display area and the fifth display area.

It is understood that the third edge may also be a complete edge at the upper end of the fourth display area and the fifth display area.

In some embodiments, the third edge may also be a partial edge of the fourth display area and the fifth display area. That is, the third edge may be a portion extending in both directions from the abutting point of the fourth display area and the fifth display area.

In some embodiments, the fourth control area may be capable of controlling the display parameter(s) and/or display content of the fourth display area and/or the fifth display area in response to a target control operation; and/or, the third edge may be all or part of the edge of the fourth display area and the fifth display area.

In some embodiments, in the electronic device, the control area may be capable of displaying content associated with the display content of adjacent display areas; or the control area may be capable of displaying content distinct from the display content of the corresponding display areas; or the control area may not have a display function; or the control area may also be capable of controlling the display parameter(s) and/or display content of its own area in response to a target control operation; or, the configuration parameter(s) of the control area may be capable of being updated according to change(s) in the display layout of the display screen.

The control area may be able to serve as an extension of an adjacent display area, displaying content related to the display content in that adjacent display area. The content related to the display content may be content related to the substantial content being displayed. For example, when the display area is playing video A, the control area may act as an extension of the display area, playing video A together with the display area. In some other embodiments, the content related to the display content may also be content related to the theme or style displayed in the adjacent display area. For example, when the display area is currently showing a video conference, the control area may act as an extension of that display area, displaying related content such as meeting assistant tools for the video conference.

In some embodiments, the control area may display content distinct from the display content of the display areas. The content may be content that distinguishes the control area from the display areas. For example, the control area may display a black background with a starry sky and a comet moving in the sky. Further, a color may be extracted from the current dominant color tone of the display area, and the control area may display solid color content according to the extracted color. In some other embodiments, a preset fixed color or pattern may be displayed in the control area, as long as the control area can be distinguished from the display area. Additionally, the control area may display application icons and/or function controls, and the function controls can be, for example, controls for screen casting.

In some embodiments, the control area may respond to a target control operation, to control the first display area and the second display area to display the same content; or, respond to a target control operation, to control the first display area and the second display area to display different content; or, respond to a target control operation, to control the first display area and the second display area to jointly display certain content.

In some embodiments, for the display screen casting function, either the first display area or the second display area may be used as a casting area, and the casting content may be part or all of the content in the casting area.

In some embodiments, the control area may not have a display function. That is, the control area may not display any content and may be in a black screen state.

It should be noted that when the control area is in a black screen state, it may still have touch functionality. That is, the control area may still be able to provide touch control functionality. For example, the control area may be a touch bar.

When the target control operation is an operation to control the display parameter(s) and/or display content of the control area, the control area may respond to the target control operation and control its own display parameter(s) and/or display content.

For example, assuming the target control operation is to turn off the display of a display area adjacent to the control area, the control area may respond to the target control operation by displaying an instruction to turn off the display area, or displaying no content, or displaying an animation, or displaying a switch control, etc.

In some embodiments, change(s) in the display layout of the display screen may include change(s) in the number of the display areas on the display screen or change(s) in their spatial positional relationship.

For example, change(s) in the display layout of the display screen may be a switch from a two-screen configuration (the display area includes two display areas) to a three-screen configuration (the display includes three display areas). As another example, change(s) in the display layout of the display screen may also be a switch from a two-screen configuration to a four-screen display, as shown in FIG. 14, where the display screen may include four display areas. As another example, change(s) in the display layout of the display screen may also be a switch from a state where two display areas are coplanar to a state where two display areas are not coplanar, for example, two display areas having a certain angle in three-dimensional space and forming a “folded” state or a “tent” state.

In some embodiments, the configuration parameter(s) of the control area may include display configuration parameter(s) or control permission parameters. For example, the display configuration parameter(s) may include transparency parameters, area size parameters, area position parameters, area color parameters, or content parameters of the control area during display. The control permission parameters may include the number of controllable objects or controllable functions. For example, the first display area may be the controllable objects, the number of the controllable objects may be 1, and the controllable functions may include the display status or display brightness.

For example, during switching from a two-screen configuration to a three-screen configuration, the area position parameters of the control area may be updated accordingly. For example, the area position parameters of the control area may switch from a certain c1 area of the display screen in the two-screen configuration to a c2 area of the display screen in the three-screen configuration, where c1 and c2 are two different areas. Simultaneously, the control permission parameters of the control area may be updated accordingly. For example, the control permission may switch from controlling two display areas in the two-screen configuration to controlling only one display area in the three-screen configuration.

In some embodiments, the device body may include a first body, a second body, and a first hinge assembly connecting the first body and the second body to enable relative rotation between them.

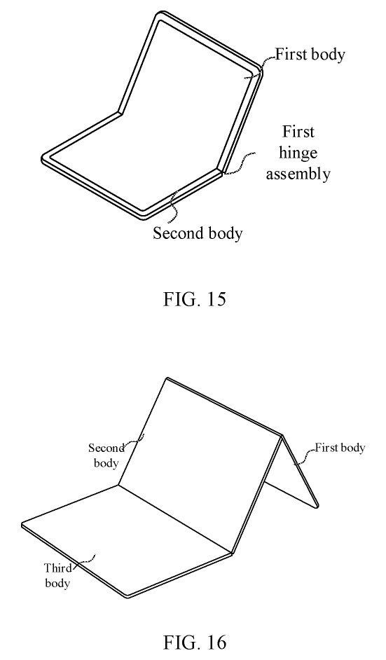

For example, as shown in FIG. 15, both the first body and the second body are housings for accommodating the display screen. The first body and the second body may rotate relative to each other via the first hinge assembly, thereby forming a foldable tablet as shown in FIG. 15.

In some embodiments, the first display area may be disposed at the first body, and the second display area may be disposed at the second body. The first control area may be disposed corresponding to the first hinge assembly to cover the first hinge assembly.

In some embodiments, for example, a direction connecting the first body and the second body may be the horizontal direction, and a direction perpendicular to the horizontal direction may be the direction for measuring the vertical height of the first control area. The vertical height of the first control area may be equal to the product of the bending radius of the first hinge assembly and π. That is, the vertical height of the first control area may be equal to half of the circumference of a circle.

In some embodiments, the device body may further include a third body rotatably connected to the second body. Relative rotation between at least two of the first body, the second body, and the third body may enable the electronic device to have different device forms.

In some embodiments, a sixth display area may be provided at the third body. The first control area may control the display parameter(s) and/or display content of the first display area and/or the sixth display area. In some other embodiments, the position of the first control area may change with the device form of the electronic device. In some other embodiments, the third body may be provided with an input device for data input by a user.

Exemplarily, as shown in FIG. 16, the first body, the second body, and the third body are all display screens. When the second display area of the second body and the sixth display area of the third body are coplanar, the first control area may control not only the first display area of the first body but also the second display area and the sixth display area simultaneously. In this case, the sixth display area may be used as an extension area of the second display area.

In some other embodiments, the first control area may also be used only to control the display parameter(s) and/or display content of the second display area or the sixth display area.

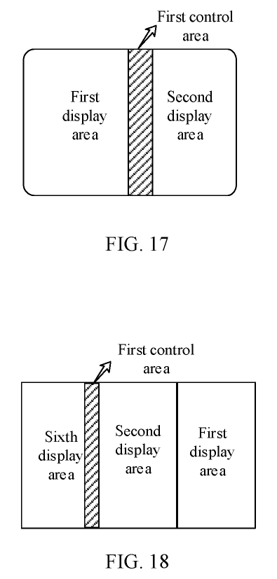

In some embodiments, the position or size of the first control area may be reconfigured according to the device form of the electronic device. The specific configuration method is not limited in the present disclosure. For example, the area of the first control area may be expanded by extending a part of the second display area into the first control area, as shown in FIG. 17. This may expand a part of the second display area into the first control area, thereby increasing the display area of the first control area. The position of the first control area may also be changed, for example, by moving the position of the first control area closer to the sixth display area, as shown in FIG. 18. After moving the position of the first control area closer to the sixth display area, the first control area may be located at the junction of the second display area and the sixth display area, and a part of the sixth display area may also be extended into the first control area.

In some embodiments, the electronic device including the first body, the second body, and the third body, may have a “tri-fold” device form. The position of the first control area may be reconfigured based on the positions of the hinge area between the first body and the second body, and the hinge area between the second body and the third body. For example, if the position of the hinge area between the first body and the second body is higher than the position of the hinge area between the second body and the third body, the position of the first control area may remain unchanged, still located between the first display area and the second display area. Otherwise, the first control area may be moved to the hinge area between the second display area and the third display area.

Therefore, the control area used to control the display areas may change with the device form of the electronic device. Thus, in actual use of the electronic device, whether it is a “bi-fold” or “tri-fold” device, the user may conveniently and quickly use the control area to control different display areas in any form of the electronic device, improving the intelligence and interactivity of the electronic device.

In some embodiments, the input device may be a physical keyboard and/or a touchpad.

In some embodiments, as shown in FIG. 19, a keyboard is provided at the third body, and the electronic device based on this configuration may be a foldable laptop computer.

The present disclosure provides an electronic device including a device body and a display screen disposed at the device body. The display screen may include at least two display areas and control area(s) disposed outside the at least two display areas; where the control area(s) are capable of controlling the display of at least one of the at least two display areas in response to a target control operation. Therefore, the display screen of the electronic device may display the control area(s), which may be used to receive target control operations. Thus, the electronic device may control different display areas on the display screen by responding to the target control operations received by the control area(s), thereby greatly improving the convenience of control and display effect of partitioned display.

Some embodiments of the present disclosure also provide an electronic device including a device body and a display screen disposed at the device body, where the display screen includes at least one display area and a control area abutting at least one of the display areas.

In some embodiments, the control area may be configured to have an enabled state and a disabled state. In the enabled state, the control area may be able to respond to a target control operation to control the display parameter(s) and/or display content of at least one display area on the display screen; and/or, in the disabled state, the control area may be in any one of a screen-off state, a hidden state, or a prohibited state.

In some embodiments, the target control operation may represent an operation for controlling the display of the display areas. The target control operation may be a control command generated based on controls, interactive gestures, etc., to control the display content, display parameter(s), display mode, display effects, etc., of at least two display areas.

In various embodiments, the display screen may include only one display area, or may have a two-screen configuration (including two display areas), a three-screen configuration (including three display areas), or a four-screen configuration (including four display areas).

In some embodiments, the device body may include a first body, a second body, a first hinge assembly connecting the first body and the second body to achieve relative rotation between the first body and the second body, and a third body rotatably connected to the second body.

In some embodiments, a second hinge assembly may be used to connect the second body and the third body to achieve relative rotation between them.

In some embodiments, the display screen may include a first display area disposed at the first body and a second display area disposed at the second body.

In some embodiments, a control area may be disposed corresponding to a first hinge assembly and located between the first display area and the second display area.

In some embodiments, the relative rotation between the first body, second body, and third body may allow the electronic device to have different device forms.

In some embodiments, when the electronic device is in a first device form, the control area may be in a display state and output target window content, the angle between the first body and the second body may be within a first angle range, and the angle between the second body and the third body may be within a second angle range. And/or, when the electronic device is in a third device form, the control area may be in any of a screen-off state, a hidden state, or a prohibited state, and the angle between the second body and the third body may be within a fourth angle range.

In some embodiments of the present disclosure, the target window content may or may not be related to the content displayed in the display areas.

Exemplarily, as shown in FIG. 16, the first device form may be a form where the angle between the first body and the second body is within a first angular range (0 to 120 degrees), and the angle between the second body and the third body is not parallel (within a second angular range).

In some embodiments of the present disclosure, in the third device form, the angle between the plane where the second display area of the display screen is located and the plane where the third display area is located may be within a third angular range, or the angle between the plane where the second display area of the display screen is located and the third body may be within a fourth angular range, where the third body is a body capable of supporting the display screen.

In some embodiments of the present disclosure, the third angle range may be 0 to 120 degrees (including 120 degrees).

In some embodiments of the present disclosure, the fourth angle range may be a range smaller than a preset angle. The preset angle is not limited in the present disclosure; for example, it may be 45 degrees or 60 degrees.

In some embodiments of the present disclosure, the third body may be provided with a third display area of the display screen or an input device of the electronic device. And/or, the electronic device may further include a processor capable of performing at least one of: in response to the electronic device switching from the first device form to the third device form, controlling the control area to switch from an enabled state to a disabled state; in response to the angle between the first body carrying the first display area and the second body carrying the second display area switching from a first angle to a second angle, controlling the control area to always be in a disabled state; or controlling the control area to output the corresponding window content by the target input method and/or controlling the area parameters of the control area based on the form change parameters of the electronic device.

In some embodiments of the present disclosure, the input device may be a keyboard component.

In some embodiments of the present disclosure, the first angle may be 0 degrees, and the second angle may be 180 degrees.

In some embodiments of the present disclosure, the form change parameters may be obtained through sensors built into the electronic device. For example, the electronic device may detect the current angle between the second display area and the first display area through a built-in angle sensor. After the lower-level angle sensor obtains the angle, it may upload the angle to an upper-level application of the electronic device. The upper-level application may control the display, disappearance, expansion, or contraction of the control area according to the current angle.

In some embodiments of the present disclosure, the target input method is not specifically limited. For example, the target input method may include dynamic fly-in, gradual opacity, or step-by-step scanning appearance. The control area may generally appear directly when the electronic device is folded to a specified angle, or it may “gradually appear” when folded to a specified angle. The gradual appearance may include a form gradient, such as gradually growing outwards from the center, slowly transforming from a line into a complete control area, or gradually growing outwards from one side of the control area to the other. The gradual appearance may also include a transparency gradient, such as from completely transparent to opaque; or a combination of form and transparency gradients.

In some embodiments of the present disclosure, the area parameters of the control area may include the width or height of the control area, and the area parameters may be dynamically adjusted.

The present disclosure provides an electronic device including a device body and a display screen disposed at the device body. The display screen may include at least one display area and a control area abutting at least one of the display areas. The control area may be configured to have an enabled state and a disabled state. In the enabled state, the control area may respond to the target control operation to control the display parameter(s) and/or display content of at least one display area on the display screen; and/or, in the disabled state, the control area may be in any one of a screen-off state, a hidden state, or a prohibited state. Therefore, the display screen of the electronic device in the present disclosure may display a control area, which may have two states: an enabled state and a disabled state. Based on the control area in the enabled state, flexible control of the display areas may be achieved. When the display areas do not need to be operated, the control area may be in a disabled state where it is not displayed. This may not only allow for flexible control of the display areas for partitioned display, improving the partitioned display effect of the display screen, but also allows the control area to be invoked in the absence of needing to operate the display areas, greatly enhancing the intelligence of the electronic device.

Another embodiment of the present disclosure provides another electronic device including a device body and a display screen disposed at the device body. The display screen may include at least one display area and a control area abutting at least one of the display areas. The control area may be provided with target window content, which may be capable of controlling the display parameter(s) and/or display content of at least one display area on the display screen in response to a target control operation.

In some embodiments of the present disclosure, the target window content may or may not be related to the display content of the display areas.

In some embodiments of the present disclosure, the target control operation may represent an operation for controlling the display of the display areas. The target control operation may be a control command generated based on controls, interactive gestures, etc., to control the display content, display parameter(s), display mode, display effect, etc., of at least two display areas.

In some embodiments of the present disclosure, the display screen may have only one display area, or it may be in a two-screen configuration (including two display areas), or a three-screen configuration (including three display areas), or a four-screen configuration (including four display areas).

It may be understood that as the distribution of the display areas change(s), the position of the control area adjacent to at least one of the display areas may also be adjusted accordingly. That is, the control area in the present disclosure may be flexibly distributed with at least two display areas on the display screen in various arrangements, meeting more practical usage scenarios, facilitating the display of content, and effectively improving the intelligence of the electronic device.

For example, the control area may adjust the display brightness parameters of the first display area and the second display area in the two-screen configuration in response to a user’s target control operation. It may also control the size of the first display area in response to a user’s target control operation to adjust the size of the first display area.

For example, the control area may control the display of a corresponding drawing application window in the first display area in response to a user’s target control operation to open the drawing application in the first display area, thereby enabling the first display area to respond to operations in the current drawing application.

For example, the control area may control the display of the real-time image captured by the camera in response to a user’s target control operation to open the camera via gesture.

In some embodiments of the present disclosure, the device body may include a first body, a second body, a first hinge assembly connecting the first body and the second body to enable relative rotation between them, and a third body rotatably connected to the second body.

In some embodiments of the present disclosure, the display screen may include a first display area disposed at the first body and a second display area disposed at the second body.

In some embodiments of the present disclosure, the control area may be positioned corresponding to the first hinge assembly and located between the first display area and the second display area.

Exemplarily, as shown in FIG. 15, the control area may be located between the first display area of the first body and the second display area of the second body, i.e., the control area may be displayed on the first hinge assembly.

In some embodiments of the present disclosure, the relative rotation between the first body, the second body, and the third body may allow the electronic device to have different device forms. In different device forms, the control area may output the same or different window content. And/or, the control area may be provided with a switch control capable of controlling the display parameter(s) of the first display area and/or a casting control capable of controlling the display content of the first display area.

Exemplarily, as shown in FIG. 16, the first body, the second body, and the third body may achieve relative rotation, thereby allowing the electronic device to have different device forms, and the display of the control area may also change accordingly with the change in the device form of the electronic device.

In some embodiments of the present disclosure, the electronic device including a first body, a second body, and a third body, may have a “tri-fold” device form, and the position of the first control area may be reconfigured based on the respective positions of the hinge area between the first body and the second body and the hinge area between the second body and the third body. For example, when the position of the hinge area between the first body and the second body is higher than the position of the hinge area between the second body and the third body, the position of the control area may remain unchanged, still located between the first display area and the second display area. Otherwise, the control area may move to the hinge area between the second and third display areas.

In some embodiments of the present disclosure, a second hinge assembly may be used to connect the second body and the third body to achieve relative rotation.

The present disclosure provides an electronic device, including a device body and a display screen disposed at the device body. The display screen may include at least one display area and a control area abutting at least one of the display areas. The control area may be provided with target window content, which may respond to target control operations to control the display parameter(s) and/or display content of at least one display area on the display screen. Therefore, the display screen of the electronic device in the present disclosure may display a control area, which may be provided with target window content, thereby enabling the control area to receive and respond to target control operations to control the display parameter(s) and/or display content of at least one display area. In other words, based on the control area, efficient interaction between the electronic device and the user may be achieved, greatly improving the interactivity and intelligence of the electronic device.

The description of the control method in the present disclosure is similar to that of the above-described electronic device embodiments and has similar beneficial effects. Therefore, it will not be repeated. For technical details not disclosed in the control method embodiments, references may be made to the description of the electronic device embodiments in the present disclosure for understanding.

Based on the above embodiments, the present disclosure may be a control method applied to an electronic device. The control method for the electronic device may include:

S101, in response to a target trigger event, controlling the display screen of the electronic device to have a first display area, a second display area, and a control area disposed between the first display area and the second display area.

In some embodiments of the present disclosure, the electronic device may, in response to the target trigger event, control the display screen of the electronic device to have a first display area, a second display area, and a control area disposed between the first display area and the second display area.

In some embodiments of the present disclosure, the target trigger event may be an event used to trigger the display of the first display area, the second display area, and the control area on the display screen. The triggering method of the target trigger event is not limited in the present disclosure. For example, the target trigger event may include string commands, voice commands, gesture commands, touch trajectory commands, device form change(s), specific button triggers, switching of the user object to a specific object or multiple objects, change(s) in the running application, change(s) in the usage environment, etc.

In some embodiments of the present disclosure, the target trigger event may include a first target trigger event and a second target trigger event. The first target trigger event may be an event that enables the control area provided at the display screen; and the second target trigger event may be an event contrary to the first target trigger event, that controls the control area to switch to a disabled state.

For example, for a target trigger event of the device form change type, assuming the electronic device is the tablet shown in FIG. 15, the triggering of the target trigger event may be determined when the tablet switches from a closed state to an unfolded state; or, assuming the electronic device is the laptop shown in FIG. 19, the triggering of the target trigger event may be determined when the laptop switches from a closed state to an unfolded state.

As another example, for a target trigger event of the gesture command type, assuming the electronic device is the tablet shown in FIG. 15, the triggering of the target trigger event may be determined when the tablet detects a specific gesture command.

As another example, for a target trigger event of the specific button trigger type, assuming the electronic device is the laptop shown in FIG. 19, the triggering of the target trigger event may be determined when the laptop detects a power button press.

In some embodiments of the present disclosure, the display screen may be a flexible screen or a rigid screen. Correspondingly, in some embodiments, the first display area, the second display area, and the control area may all be areas within the flexible screen. In other embodiments, the first display area and the second display area may be rigid screens, and the control area may be a flexible screen positioned between the two rigid screens.

In some embodiments of the present disclosure, the control area may respond to target control operations to control the display parameter(s) and/or display content of the first display area and/or the second display area.

Therefore, the electronic device in the present disclosure, through the control area on the display screen, may separately control the display of different display areas on the display screen. This may not only improve the effect of partitioned display but also greatly enhance the convenience of partitioned or split-screen display, thereby improving the intelligence of the electronic device.

In some embodiments of the present disclosure, the control method of the electronic device may further include:

S102: in response to change(s) in the display layout information of the display screen of the electronic device, updating the configuration parameter(s) of the control area.

In some embodiments of the present disclosure, the electronic device may update the configuration parameter(s) of the control area in response to change(s) in the display layout information of the display screen of the electronic device.

In some embodiments of the present disclosure, the display layout information may be information characterizing change(s) in the number of display areas on the display screen or change(s) in their spatial positional relationships. For example, the display layout of the display screen may change from a two-screen configuration (the display area includes two display areas) to a three-screen configuration (the display screen includes three display areas), or may change from a two-screen configuration to a four-screen configuration, as shown in FIG. 14, where the display screen includes four display areas; or may change from a state where two display areas are coplanar to a state where two display areas are not coplanar, for example, the two display areas have a certain angle in three-dimensional space, forming a “folded” state or a “tent” state.

In some embodiments of the present disclosure, the configuration parameter(s) may include display configuration parameter(s) or control permission parameters for the control area. For example, the display configuration parameter(s) of the control area may include transparency parameters, area size parameters, area position parameters, area color parameters, or content parameters when the control area is displayed. The control permission parameters may include the number of controllable objects or controllable functions, such as the first display area being a controllable object, the number of controllable objects being 1, or controllable functions including display status and display brightness. For example, during the switching from a two-screen configuration to a three-screen configuration, the area position parameters of the control area may be updated accordingly.

For example, the control area may switch from a c1 area of the display screen in the two-screen configuration to a c2 area of the display screen in the three-screen configuration, where c1 and c2 are two different areas. At the same time, the control permission parameters of the control area may be updated accordingly. For example, the control permission may switch from controlling two display areas in the original two-screen configuration to controlling one display area in the three-screen configuration.

It is understood that, based on the aforementioned embodiments of the electronic device, relative rotation between the first body and the second body of the electronic device, or relative rotation between at least two of the first body, the second body, and the third body when the electronic device includes the first body, the second body, and the third body, may change the device form. The present disclosure correspondingly provides a control method in which the electronic device, in response to a target trigger event, controls its display screen to have a first display area, a second display area, and a control area disposed between the first display area and the second display area. The control area may respond to a target control operation to control the display parameter(s) and/or display content of the first display area and/or the second display area. Therefore, the electronic device in the present disclosure may respond to a target trigger event to display different display areas on the display screen, as well as a control area for controlling the display areas. This control area may receive target control operations to control the display parameter(s) and/or display content of the display areas accordingly, thereby greatly improving the control convenience and display effect of partitioned display.

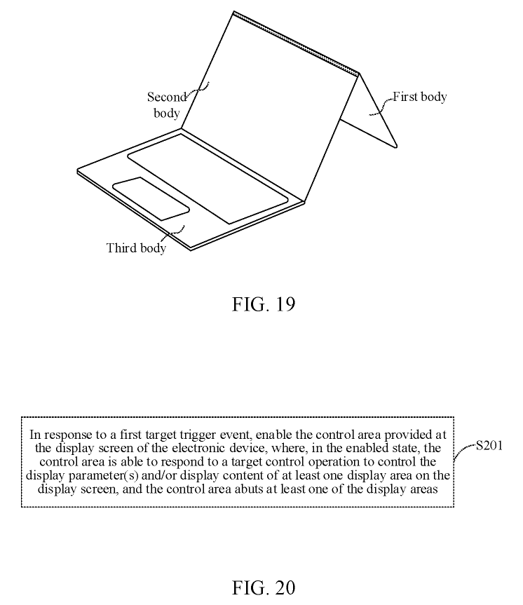

Another embodiment of the present disclosure provides another control method, as shown in FIG. 20. The control method may include:

S201: in response to a first target trigger event, enabling the control area provided at the display screen of the electronic device, where, in the enabled state, the control area is able to respond to a target control operation to control the display parameter(s) and/or display content of at least one display area on the display screen. The control area may abut at least one of the display areas.

In an embodiment of the present disclosure, the electronic device may, in response to a first target trigger event, enable a control area provided at the display screen of the electronic device. The enabled state may indicate that the control area is in an activated state, and when the control area is in the enabled state, the electronic device may implement control operation functions based on the control area.

In an embodiment of the present disclosure, the first target trigger event may indicate an event that enables the control area provided at the display screen. The first target trigger event is not specifically limited in the present disclosure. For example, the first target trigger event may include string commands, voice commands, gesture commands, touch trajectory commands, device form change(s), specific button triggers, switching of the user object to a specific object or multiple objects, change(s) in the running application, change(s) in the usage environment, etc.

In some embodiments of the present disclosure, the control area may not be necessarily in a display state when enabled; and it may remain in an off-screen or non-display state.

In some embodiments of the present disclosure, the display screen may have only one display area, or it may be in a two-screen configuration (including two display areas), a three-screen configuration (including three display areas), or a four-screen configuration (including four display areas).

In some embodiments of the present disclosure, the control area may be adjacent to the edges of the display areas. For example, the control area may be located at the top, bottom, left, or right side of the display screen. For example, when the control area is located at the top of the display screen, the display areas may be located below the control area and adjacent to its bottom edge; when the control area is located at the bottom of the display screen, the display areas may be located above the control area and adjacent to its top edge; when the control area is located on the left side of the display screen, the display areas may be located to the right of the control area and adjacent to its right edge; or, when the control area is located on the right side of the display screen, the display areas may be located to the left of the control area and adjacent to its left edge.

In some embodiments of the present disclosure, the target control operation may represent an operation used to control the display of one display area. The target control operation may be a control command generated based on controls, interactive gestures, etc., to control the display content, display parameter(s), display mode, display effects, etc., of the at least two display areas.

In some embodiments of the present disclosure, the control area may abut at least one of the display areas.

In some embodiments of the present disclosure, the control area may be disposed between two split display areas in a two-screen configuration, or at the top or bottom edge. The control area may also be set between any two split display areas in a three-screen configuration, or at the top or bottom edge, etc., in the absence of specific limitation.

In some embodiments of the present disclosure, the first target trigger event may be triggered by at least one of: determining the generation of the first target trigger event in response to detecting that the electronic device switches to a first target device form; determining the generation of the first target trigger event in response to obtaining first target input data acting on the electronic device; or determining the generation of the first target trigger event in response to detecting a change in the usage information of the electronic device. And/or, enabling the control area provided at the display screen of the electronic device may include at least one of: controlling the control area located at a specified position on the display screen of the electronic device to have target display parameter(s) and/or output target display content; controlling the display area on the display screen of the electronic device to match the first target trigger event as the control area; controlling the first application to be in a target operation state and/or controlling the application window of the first application to display output to the control area provided at the display screen, where the first application may be an application capable of responding to target control operations to control the display parameter(s) and/or display content of at least one display area on the display screen.

In some embodiments of the present disclosure, based on the structure of the electronic device in the aforementioned embodiments, for example, as shown in FIG. 16, the first target device form may be a form where the angle between the second body and the third body is larger than 45 degrees, or a form where the angle between the first body and the second body is less than 120 degrees.

In some embodiments of the present disclosure, the first target input data may be string commands, voice commands, gesture commands, touch trajectory commands, command data generated by tapping the target button, or gesture trajectory data, etc., for enabling the control area, and the present disclosure does not impose specific limitations.

Exemplarily, when the electronic device detects a preset gesture command for enabling the control area through the display screen, the first target trigger event may be determined to be generated; or when the electronic device recognizes air gesture trajectory data for enabling the control area through the camera, the first target trigger event may be determined to be generated; or when the electronic device detects a tapping operation of the target button, the first target trigger event may be determined to be generated.

In some embodiments of the present disclosure, the usage information may include any information regarding the use of the electronic device. For example, the usage information may include information about users. When the electronic device detects that the current user has switched from a single person to two people, it may determine that the usage information has changed, thereby determining that the control area needs to be activated to grant control permissions to the other party, i.e., determining that the first target trigger event has been generated.

In some embodiments of the present disclosure, the specified position is not specifically limited. For example, the specified position may be a foldable area of the electronic device, or the area corresponding to the hinge, or the edge area of the display screen.

In some embodiments of the present disclosure, the target display parameter(s) may include parameters characterizing a black screen state, a low brightness state, a marquee selection state, or a lit state, etc.

Exemplarily, when the area of the electronic device corresponding to the hinge is displayed in a low brightness state, it may be determined that the current control area may be in an enabled state, i.e., the current control area may respond to the target control operation.

In some embodiments of the present disclosure, the specific content of the target display content is not specifically limited. For example, the target display content may include preset designs such as rainbow bars, starry skies, casting buttons; or control buttons (fast forward, pause, volume adjustment, etc.), extended display content, related application icons, etc., generated based on the display content of adjacent screens; or control bars or buttons for controlling the display parameter(s) of adjacent screens.

In some embodiments of the present disclosure, the position of the control area may change with the device form or with different usage scenarios.

In some embodiments of the present disclosure, the target operation state may be a foreground operation state or a started operation state, that is, controlling the first application to start running or switch to foreground running.

In some embodiments of the present disclosure, the control area may be regarded as the interface window area of the first application. The first application may be an application capable of controlling the display parameter(s) and/or display content of the first display area and the second display area, that is, an application that exclusively occupies the control area.

In some embodiments of the present disclosure, the first application may be an application capable of executing corresponding control operations based on control commands generated in response to the target control operation.

In some embodiments of the present disclosure, enabling the control area on the display screen of the electronic device may include at least one of: in response to detecting that the electronic device switches to a first device form, controlling the control area corresponding to the first hinge assembly to be in a display state and/or output first window content, where the first hinge assembly is a structure on the electronic device capable of causing the display screen to change form and the display screen has a first display screen form in the first device form; in response to detecting that the electronic device switches to a second device form, configuring the display area corresponding to the second hinge assembly as a control area to output second window content, where the second hinge assembly is a structure on the electronic device capable of causing the display screen to change form and the display screen has a second display screen form in the first device form; in response to obtaining first target input data acting on the electronic device, controlling the display area on the display screen matching the source of the first target input data as a control area for outputting third window content; or in response to detecting that the users of the electronic device change(s), controlling the control area corresponding to the first hinge assembly to output fourth window content, where the first hinge assembly is a structure on the electronic device capable of causing the display screen to change form.

In some embodiments of the present disclosure, as shown in FIG. 15, the first device form may be a form where the first body and the second body rotate at a certain angle because of the rotation of the first hinge assembly.

In some embodiments of the present disclosure, the control area in the display state may make the control area different from the first display area of the first body and the second display area of the second body in terms of display color, brightness, display mode, or display content.

In some embodiments of the present disclosure, in the first device form, at least the angle between the first body and the second body of the electronic device may be less than or equal to 120 degrees.

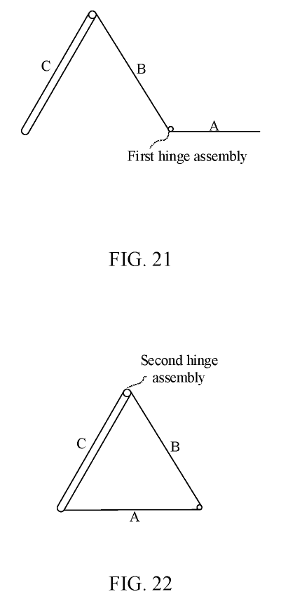

In some embodiments of the present disclosure, when the first body, the second body, and the third body of the electronic device are all display screens, the second body and the third body may be in a “tent” shape, and the first body and the second body may form an obtuse or acute angle, which may be considered as the second device form. For example, the electronic device form shown in FIG. 21 and FIG. 22 may be considered as the second device form, where the first body A and the second body B rotate via a first hinge assembly, and the second body B and the third body C rotate via a second hinge assembly. Based on the first hinge assembly and the second hinge assembly, various forms may be achieved, such as the second body and the third body forming a “tent” shape, and the first body and the second body forming an obtuse or acute angle.

In some embodiments of the present disclosure, the second hinge assembly may be a hinge between the second body and the third body.

In some embodiments of the present disclosure, the second window content may be the same as or different from the first window content. For example, the second window content may be updated or adjusted according to its position or the content of the display areas.

In some embodiments of the present disclosure, in the second device form, at least the angle between the first body and the second body of the electronic device may be less than or equal to 120 degrees, and the angle between the second body and the third body may be greater than 45 degrees.

In some embodiments of the present disclosure, when the first target input data comes from a touch trajectory, the area where the touch trajectory is located may be configured as the control area.

In some embodiments of the present disclosure, when the first target input data comes from string input, the hinge area may be configured as the control area.

In some embodiments of the present disclosure, when the first target input data is triggered by a button, the hinge area or the bottom edge area may be configured as the control area.

In some embodiments of the present disclosure, the third window content may be the same as or different from the first window content or the second window content.

In some embodiments of the present disclosure, when the electronic device detects that the usage object has switched from single-person use to dual-person use, it may determine that the usage object has changed, and may control the control area corresponding to the first hinge to output the fourth window content.

In some embodiments of the present disclosure, the fourth window content may be the same as or different from the first window content, the second window content, or the third window content.

In some embodiments of the present disclosure, the control method may further include, when the electronic device is in the first device form, controlling the display screen to further include a first display area and a second display area disposed at opposite sides of the control area, where the included angle between the planes where the first display area and the second display area are located may be within a first angle range, or the included angle between the plane containing the second or first display area and the supporting surface of the electronic device may be within a second angle range.

In some embodiments of the present disclosure, the first angle range may be 0 to 120 degrees.

Exemplarily, the supporting surface of the electronic device may be understood as a desktop. When the included angle between the planes where the first display area and the second display area are located is within the range of 0 to 120 degrees, and the plane where the second display area is located is not parallel to the desktop, it may be determined that the electronic device is in the first device form.

Exemplarily, when the included angle between the planes where the first display area and the second display area are located is 80 degrees, and the included angle between the plane where the second display area is located and the desktop or the plane where the third display area is located is greater than 45 degrees, it may be determined that the electronic device may be in the first device form.

In some embodiments of the present disclosure, when the electronic device is in a second device form, the display screen may further include a first display area and a second display area disposed at opposite sides of the control area, and a third display area abutting the second display area, where the angle between the planes where the second display area and the third display area are located is within a third angle range.

In some embodiments of the present disclosure, the third angle range may be 0 to 120 degrees (including 120 degrees).

In some embodiments of the present disclosure, the control area may be controlled to output the corresponding window content in a target input method based on the form change parameters of the electronic device.

In some embodiments of the present disclosure, the form change parameters may be obtained through sensors built into the electronic device. For example, the electronic device may detect the current angle between the second display area and the first display area through a built-in angle sensor. After the lower-level angle sensor obtains the angle, it may upload the angle to the upper-level application of the electronic device. The upper-level application may control the display, disappearance, expansion, or contraction of the control area according to the current angle.

In some embodiments of the present disclosure, the target input method is not specifically limited. For example, the target input method may include dynamic fly-in, gradual opacity, or step-by-step scanning appearance. The control area may generally appear directly when the electronic device is folded to a specified angle, or it may “gradually appear” when folded to a specified angle. The gradual appearance may include a shape gradient, such as gradually growing outwards from the center, slowly transforming from a line into a complete control area, or gradually growing outwards from one side of the control area to the other. The gradual appearance may also include a transparency gradient, such as from completely transparent to opaque; or a combination of shape and transparency gradients.

In some embodiments of the present disclosure, controlling the control area on the display screen of the electronic device to be in an enabled state may include at least one of: controlling the display screen of the electronic device to run target firmware to control the display screen to divide a display area at a specified position that may control the display parameter(s) and/or display content of at least one edge-connected display area as the control area; or requesting display resources or control permissions for the control area from the operating system of the electronic device based on the display screen information of the display screen and the position information of the control area on the display screen, to configure the control area using the display resources and control permissions to enable it.

Exemplarily, the area at a specified position may be enabled as the control area by switching the running firmware of the display screen. For example, the running firmware 1 enables the area a1 of the display screen as the control area, or the running firmware 2 enables the area a2 of the display screen as the control area, where the area a1 and the area a2 are different areas on the display screen.

Requesting display resources or control permissions for the control area from the operating system of the electronic device may allow for exclusive display and control to enable the control area.

In some embodiments of the present disclosure, the control method may further include at least one of: in response to receiving a second target trigger event, controlling the control area to switch from an enabled state to a disabled state; or in response to the angle between the plane where the first display area and the second display area disposed at the display screen of the electronic device are located switching from a first angle to a second angle, controlling the control area to always be in a disabled state. In the disabled state, the control area may be in any one of a screen-off state, a hidden state, or a prohibited state.

In some embodiments of the present disclosure, the second target trigger event may be an event contrary to the first target trigger event, that control the control area to switch to a disabled state. The triggering method of the second target trigger event is not specifically limited in the present disclosure, and, for example, it may be triggered by instructions, form change(s), change(s) in usage information, etc.

Exemplarily, when the electronic device detects that there is currently no object in use, it may determine that a second target trigger event has occurred and switch the control area from the enabled state to the disabled state.

It is understood that the control area in the disabled state cannot respond to target control operations.

In some embodiments of the present disclosure, the first angle may be 0 degrees, the second angle may be 180 degrees.

For example, in the laptop computer shown in FIG. 12, during the process of the angle between the plane corresponding to the first display area and the plane corresponding to the second display area switching from 0 degrees to 180 degrees, the control area between the first display area and the second display area may always be in the disabled state.

In some embodiments of the present disclosure, controlling the control area to switch from the enabled state to the disabled state, may include at least one of: in response to detecting that the electronic device switches to a third device form different from the first device form or different from the second device form, controlling the control area to switch to any one of a screen-off state, a hidden state, or a prohibited state, where the angle between the second display area of the display screen and the plane where the third display area is located is within a third angle range, or the angle between the plane where the second display area of the display screen is located and the third body is within a fourth angle range, in the third device form, with the third body being a body capable of supporting the display screen; in response to obtaining second target input data acting on the electronic device, controlling the control area to switch to any one of a screen-off state, a hidden state, or a prohibited state; or in response to detecting a change in the usage object of the electronic device, controlling the control area to switch to any one of a screen-off state, a hidden state, or a prohibited state.

For example, as shown in FIG. 15, regardless of the relative positional relationship between the first display area and the second display area, the control area may be in the disabled state as long as the angle between the planes where the second display area and the third display area are located is less than 45 degrees.

In some embodiments of the present disclosure, the fourth angle range may be a range smaller than a preset angle. The preset angle is not limited in the present disclosure. For example, the preset angle may be 45 degrees or 60 degrees.

For example, as shown in FIG. 19, as long as the angle between the second display area and the third body (keyboard component) is less than 45 degrees, the control area may be in the disabled state.

In some embodiments of the present disclosure, the second target input data may be data that contradicts the first target input data. The second target input data may be command data or gesture trajectory data generated by string commands, voice commands, gesture commands, touch trajectory commands, pressing target keys, etc., that cause the control area to enter the disabled state, which is not specifically limited in the present disclosure.

The present disclosure proposes a control method in which an electronic device, in response to a first target trigger event, enables a control area on its display screen. In the enabled state, the control area may respond to a target control operation to control the display parameter(s) and/or content of at least one display area on the display screen. The control area may abut at least one of the display areas. Therefore, the display screen of the electronic device in the present disclosure may display a control area, which may have two states: the enabled state and the disabled state. Based on the control area in the enabled state, flexible control of the display areas may be achieved. When the display area is not needed, the control area may be in the disabled state that does not display, thus enabling flexible control of the display areas for partitioned display, improving the partitioned display effect. Furthermore, it may allow the control area to be accessed in the absence of needing to be activated, greatly enhancing the intelligence of the electronic device.

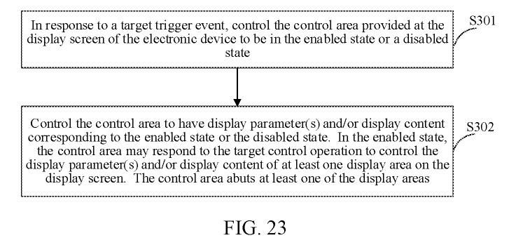

Another embodiment of the present disclosure provides another control method. As shown in FIG. 23, the method may include S301 and S302.

At 301, in response to a target trigger event, the control area provided at the display screen of the electronic device is controlled to be in the enabled state or a disabled state.

The electronic device may control the control area provided at the display screen of the electronic device to be in the enabled state or a prohibited state in response to the target trigger event.

In some embodiments of the present disclosure, the target trigger event may include a first target trigger event and a second target trigger event. The first target trigger event may be an event that enables the control area provided at the display screen; and the second target trigger event may be an event contrary to the first target trigger event, that controls the control area to switch to the disabled state.

The triggering method of the target trigger event is not limited in the present disclosure. For example, the target trigger event may include string commands, voice commands, gesture commands, touch trajectory commands, device form change(s), specific button triggers, switching of the user object to a specific object or multiple objects, change(s) in the running application, change(s) in the usage environment, etc.

In some embodiments of the present disclosure, in the enabled state, the control area may be activated and may respond to the target control operation to control the display parameter(s) and/or display content of at least one display area on the display screen.

In some embodiments of the present disclosure, in the enabled state, the control area may be not necessarily in a display state; it may remain in a screen-off state or a non-display state.

In some embodiments of the present disclosure, in the disabled state, the control area may be in a screen-off state, a hidden state, or a prohibited state, depending on the device form. Correspondingly, the display parameter(s) of the control area may include black screen display parameter(s), background display parameter(s), transparent display parameter(s), etc.

At S302, the control area is controlled to have display parameter(s) and/or display content corresponding to the enabled state or the disabled state. In the enabled state, the control area may respond to the target control operation to control the display parameter(s) and/or display content of at least one display area on the display screen. The control area may abut at least one of the display areas.

In some embodiments of the present disclosure, the electronic device may control the control area to have display parameter(s) and/or display content corresponding to the enabled state or the disabled state. In the enabled state, the control area may respond to a target control operation to control the display parameter(s) and/or display content of at least one display area on the display screen. The control area may abut at least one of the display areas.

It should be noted that the execution order of S301 and S302 is not limited in the present disclosure.

In embodiments of the present disclosure, in the enabled state, the display content of the control area may include screen casting controls, operation controls related to the content of each display area, controls indicating content or controlling the display state of each display area, such as switch controls, controls for switching display modes, or notification messages.

Exemplarily, the display area on the display screen of the electronic device may include a first display area, a second display area, and a third display area. In the enabled state, the control area may display operation controls related to the current display content in the first display area, the second display area, and the third display area. For example, when a video is currently playing in the first display area, the second display area, and the third display area, the display content of the control area may include video playback controls, including controls for controlling functions such as pausing, playing, and recording the video.

In some embodiments of the present disclosure, the control area may be adjacent to the edge of at least one of the display areas. For example, the control area may be located at the top, bottom, left, or right side of the display screen. When the control area is located at the top of the display screen, the display area may be located below the control area and adjacent to the lower edge of the control area. When the control area is located at the bottom of the display screen, the display area may be located above the control area and adjacent to the upper edge of the control area. When the control area is located on the left side of the display screen, the display area may be located to the right of the control area and adjacent to the right edge of the control area. When the control area is located on the right side of the display screen, the display area may be located to the left of the control area and adjacent to the left edge of the control area.

In some embodiments of the present disclosure, the control area may have display parameter(s) and/or display content corresponding to the enabled state or a prohibited state, including at least one of: when the control area may be configured to be enabled, the control area outputs target window content based on target reference information, where the target window content has a corresponding first target display parameter; or when the control area is configured to be disabled, the control area has a second target display parameter based on the device form information of the electronic device.

In some embodiments of the present disclosure, the target reference information may include device form information of the electronic device, output content, content to be output, change(s) in usage information, or user-defined configuration operations. Under different device forms, the display output content or the display parameter(s) of the control area may differ. The output content may be a notification message, and the content to be output may be an application interface scheduled to launch. Personalized or customized configurations may be made for different users, such that when the user change(s), the control area may trigger the display of corresponding personalized content. For user-defined configuration operations, the display may be performed according to the data configured by the user.

It may be understood that in the embodiments of the present disclosure, the first target display parameter may be a parameter characterizing the target window content. For example, when the target window content is a casting control, the first target display parameter may be a display parameter used to instruct the casting control to be displayed in the control area, such as a display mode, a display form, or a display position.

In some embodiments of the present disclosure, when the control area is configured to the disabled state, the electronic device may control the display of the control area solely based on the device form information. Furthermore, for the disabled control area, the electronic device may configure only display parameter(s), such as always-on display, transparent background display, or no display under different device forms.

In some embodiments of the present disclosure, controlling the output of target window content based on the target reference information may include at least one of: controlling the output of preset window content or window content determined based on the device form information of the electronic device; obtaining the display content and/or content to be displayed of the electronic device, and controlling the output of target window content based on the display content and/or content to be displayed; controlling the output of corresponding preset window content based on change(s) in the usage information of the electronic device; or obtaining operation data acting on the control area, and controlling the output of corresponding response results based on the operation data.

In some embodiments of the present disclosure, the content in the control area may be updated based on the device form.

In some embodiments of the present disclosure, the control area may display preset window content in its initial state. For example, the preset window content may include a switch on the left side indicating the display status of the control area A, and a casting button on the right side indicating the control area A. In some other embodiments, other spaces or display content may be preset, such as a notification bar, weather, date, etc.

In some embodiments of the present disclosure, the operation information of the electronic device may include the application running on the electronic device, the current display content, the content to be displayed, possible notification messages, runtime (e.g., battery level indicator), or operating mode. The operating mode may include whether the current mode is an extended display mode or a content copy mode. The electronic device may determine the content to be displayed in the control area and the corresponding display parameter(s) based on the above information.

In some embodiments of the present disclosure, the electronic device may also determine the target window content of the control area based on the current display content and the content to be displayed on the display screen. For example, the content to be displayed may be requested file data. The target window content may display information such as the name of the requested file data. Correspondingly, the electronic device may display corresponding control buttons, prompts, or operation controls on the control area.

For example, the change in usage information may be a switch from a single user to a dual user on the electronic device. For instance, in the laptop shown in FIG. 19, the user may be originally a single user located on one side of the keyboard. When the electronic device detects that an additional user has been added facing the folded first body, it may activate the control area to grant control permissions to the new user, allowing the control area to receive operations from the new user.

For example, the change information in usage information may also be information about switching between different types of applications, such as switching from a shared application to a two-player battle application. As shown in FIG. 16, when switching from a shared application to a two-player battle application, assuming the two-player battle application is a two-player game, the two users may respectively face the first display area and the second display area, and operate their respective interfaces on the first display area and the second display area to complete the game. In this case, the electronic device may enable the control area. Additionally, the change information in usage information may also be information about change(s) in the usage environment, such as switching from a home environment to a work or meeting environment. In this case, the electronic device may also enable the control area to share permissions with others through the control area.

In some embodiments of the present disclosure, the operation data may be understood as data that manipulates buttons or content in the control area; for example, switching, dragging, sliding, changing the size of the control area, or display parameter(s). Correspondingly, the response results may include button state switching, button position change(s), display parameter change(s), or area size adjustments.

In some embodiments of the present disclosure, the control area outputting preset window content or window content determined based on the device form information of the electronic device, or based on the operating information of the electronic device, may include at least one of: when the electronic device is in a first device form, the control area outputs first window content determined based on the operating information of the electronic device, where the display screen further includes a first display area and a second display area disposed at opposite sides of the control area; in the first device form, the angle between the planes where the first display area and the second display area are located is within a first angle range, and the angle between the plane where the second display area is located or the first display area and the bearing surface of the electronic device is within a second angle range; the first window content includes controls or prompts related to the display content of the first display area; when the electronic device is in a second device form, the control area outputs the second window content determined based on the operating information of the electronic device, where the display screen further includes a first display area and a second display area disposed at opposite sides of a control area, and a third display area abutting the second display area. The angle between the planes where the second display area and the third display area are located is within a third angle range. The second window content includes controls or prompts related to the display content of the third display area and/or the first display area. When the electronic device is in the first device form and the first display area of the display screen displays the first display content or is in a screen-off state, the control area may output preset window content. The display screen further comprises a first display area and a second display area disposed at opposite sides of the control area. In the first device form, the angle between the planes where the first display area and the second display area are located is within a first angle range, and the angle between the plane containing the second or first display area and the supporting surface of the electronic device is within a second angle range.

In some embodiments of the present disclosure, the first device form may be a form where the first body and the second body rotate through a first hinge assembly, resulting in a certain angle between the first body and the second body.

In some embodiments of the present disclosure, the first window content may be preset window content with added controls or prompts, or it may only display the relevant controls or prompts.

For example, the preset window content may include a switch on the left side controlling the display status of the first display area and a casting button on the right side controlling the first display area. When the electronic device is in the first device form, the electronic device may, based on its current operating mode being the extended display mode, determine that the first window content, in addition to displaying the switch and casting button controlling the first display area, also includes prompt content indicating the extended display mode.

In some embodiments of the present disclosure, the first angle range may be 0 to 120 degrees.

For example, the first device form may be a form where the angle between the first body and the second body is within the first angle range (0 to 120 degrees), and the angle between the second body and the third body is greater than 45 degrees.

In some embodiments of the present disclosure, the first window content may include controls or prompts related to the display content of the first display area. For example, it may include playback controls currently playing in the first display area, a brightness adjustment progress bar, or detailed information of prompt icons indicating the display content of the first display area.

For example, the electronic device form shown in FIG. 21 and FIG. 22 may be considered the second device form, where the first body A and the second body B rotate via a first hinge assembly, and the second body B and the third body C rotate via a second hinge assembly. Based on the first and second hinge assemblies, various forms may be achieved, such as the second body and the third body forming a “tent” shape, and the first body and the second body forming an obtuse or acute angle.

In some embodiments of the present disclosure, the third angle range may be 0 to 120 degrees (including 120 degrees)

The first display content may include content displayed in the first display area in the default state. For example, the first display content may be a dedicated wallpaper state. Of course, the first display content may also have different designs, such as a clock, or some personalized displays that do not involve personal privacy, including user-defined photos, images, text, etc.

For example, as shown in FIG. 16, the tablet may be regarded as being in a first device form. When the first display area corresponding to the first body is in a screen-off state, the electronic device may control the control area to output preset window content. In the first device form, the angle between the first body and the second body may be in the range of 0 to 120 degrees, the second body may not be parallel to the supporting surface of the electronic device, i.e., the desktop, and the angle between the second body and the desktop or the third body may be larger than 45 degrees.

In some embodiments of the present disclosure, controlling the output of target window content based on the display content and the content to be displayed may include at least one of: adding controls or prompts related to a first display area and/or a second display area located on opposite sides of the control area to the preset window content of the control area, thereby obtaining target window content; adding a notification message box or message notification icon of the target application of the electronic device to the preset window content of the control area, thereby obtaining target window content; or adding operable controls matching the current user’s profile information to the preset window content of the control area, thereby obtaining target window content. The preset window content of the control area may include at least functional controls for controlling the display parameter(s) and/or display content of at least one display area of the display screen.

Exemplarily, a switch control for turning on the first display area may be set in the preset window content of the control area. A casting function control for casting the content of the second display area onto the first display area may also be set in the preset window content.

In some embodiments of the present disclosure, a notification message box for the target application may be added to the preset window content to facilitate timely display of new message notifications from the target application in the absence of affecting the use of other display areas. The target application may be any application, or an application with the highest priority set by the user, which is not limited in the present disclosure. For example, if the user sets a social application as the highest priority application, the electronic device may add a notification message box for that social application to the preset window content, thereby enabling timely notifications of new messages from the social application through the control area while the user is using the electronic device, enhancing the intelligence of the electronic device.

In some embodiments of the present disclosure, by adding operable controls matching the current user’s profile information to the preset window content, the user’s habits or preferences may be more comprehensively considered, allowing frequently used function icons to be placed in the preset window for easy user operation, improving user convenience and the interactive performance of the electronic device.

For example, if the current user’s profile information indicates a teenager, operation controls for homework help and question searching, or controls related to eye protection functions, may be added to the preset window content in the control area.

In some embodiments of the present disclosure, the preset window content of the control area may at least include functional controls for controlling at least one of the display area. For example, the preset window content may at least include a switch control for controlling whether the first display area may be turned on, and/or a casting control.

In some embodiments of the present disclosure, controlling the control area to output a corresponding response result based on operation data may include at least one of: displaying a switch control at a first position in the control area, and controlling the control area to display target animation content based on a first trigger operation applied to the switch control; displaying a casting control at a second position in the control area, and controlling the control area to display application information of the cast window based on a second trigger operation applied to the casting control; displaying a mode switching control at a third position in the control area, and controlling the control area to display mode switching result feedback information based on a third trigger operation applied to the mode switching control.

In some embodiments of the present disclosure, the first trigger operation may be an operation to turn the switch control on or off, and the first trigger operation may be an operation triggered by a mouse click, touch gesture, or voice command.

In some embodiments of the present disclosure, the first position may not be limited. For example, the first position may be the far right of the control area.

Exemplarily, the target animation content may include a black background with a starry sky and a comet moving through it, or a display of a “rainbow bar”. For example, the control area may display a button to turn the display of the first display area on and off (black screen). This button may be placed on the far left facing the second display area. When the button is turned off, the first display area may not display, and the control area may display a black background with a starry sky and a comet moving through it.

In some embodiments of the present disclosure, the second position may not be limited. For example, the second position may be the far left of the control area.

The second trigger operation may be an operation of triggering the display screen casting control.

Exemplarily, the far left of the control area may be the display screen casting control. When the electronic device detects the second trigger operation of the display screen casting control, it may control the control area to display the name or icon of the currently screen casting application, or other information that may be used to indicate the currently screen casting application.

In some embodiments of the present disclosure, the third position may not be limited. For example, the third position may be the middle position of the control area.

In some embodiments of the present disclosure, the mode switching control may be a control for switching the operating mode of the display areas. For example, the operating modes of the display areas may include an extended mode, a casting mode, a mirror mode, or a copy mode. The mode switching control may be used to switch the display areas between the above-mentioned different operating modes. It may also be a control for switching the operating mode of the electronic device. For example, the operating modes of the electronic device may include a performance mode or a power saving mode, and the mode switching control may be used to provide the electronic device with the function of switching between the performance mode and the power saving mode.

In some embodiments of the present disclosure, the electronic device may control the control area to display switching result feedback information based on the third trigger operation acting on the mode switching control. The switching result feedback information may be used to indicate whether the switching operation is successfully executed, and the switching result feedback information may include switching success or switching failure.

For example, assuming the third triggering operation is to switch the operating mode of the electronic device from the performance mode to the energy saving mode, the electronic device may generate switching result feedback information based on the judgment result of whether the current electronic device has successfully switched to the energy saving mode. If the current electronic device confirms that it has successfully switched to the energy saving mode, it may generate switching result feedback information of successful switching; and, otherwise, it may generate switching result feedback information of failed switching.

In some embodiments of the present disclosure, controlling the control area to have the second target display parameter based on the device form information of the electronic device may include at least one of: when the electronic device is in the third device form, the control area may be in a screen-off state, where the angle between the second display area of the display screen and the plane where the third display area is located may be within a third angle range or the angle between the plane where the second display area is located of the display screen and the third body may be within a fourth angle range in the third device form, with the third body being the body capable of supporting the display screen; or, when the electronic device may is in a fourth device form, the control area may be in a transparent display state in the background or in the disabled state, where the first display area and the second display area of the display screen are coplanar in the fourth device form.

For example, as shown in FIG. 16, for a tablet, regardless of the relative positional relationship between the first display area and the second display area, as long as the angle between the planes where the second display area is located and the third display area is less than 45 degrees, the control area may be in the disabled state.

For example, as shown in FIG. 19, for a laptop computer, as long as the angle between the second display area and the third body (the keyboard component) is less than 45 degrees, the control area may be in the disabled state.

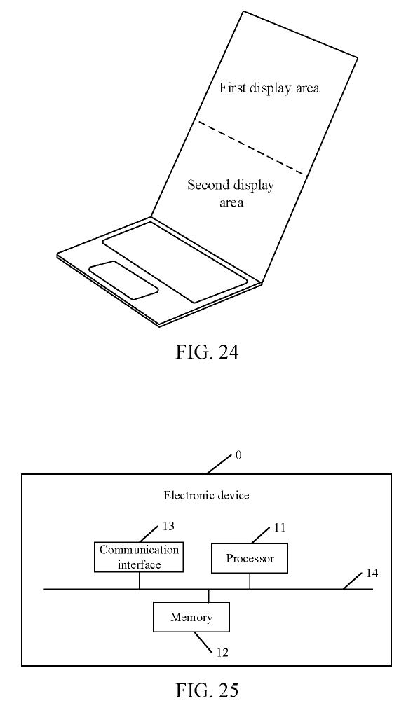

For example, as shown in FIG. 24, when the first display area of the first device and the second display area of the second device are coplanar, it may be determined that the current electronic device is in a fourth device form. At this time, the electronic device may control the control area to be in a transparent background display state or in the disabled state.

In some embodiments of the present disclosure, the control method may further include at least one of S303 to S305.

At S303, in response to a second trigger operation acting on the casting control in the control area, the cast window is controlled to be cast in a mirror mode onto the first display area of the display screen, and the control area is controlled to display application information of the cast window in opposite directions at the first and second positions, respectively.

In some embodiments of the present disclosure, the electronic device may also, in response to the second trigger operation acting on the casting control in the control area, the cast window may be controlled to be cast in a mirror mode onto the first display area of the display screen, and the control area may be controlled to display application information of the cast window in opposite directions at the first and second positions, respectively.

It should be noted that by displaying application information of the cast window in opposite directions at the first and second positions, users facing the first display area and the second display area respectively may clearly see the application information of the cast window from their respective angles.

It should also be noted that by controlling the cast window to be mirrored onto the first display area of the display screen, users facing the first display area may view the image in the correct orientation from their current angle within the first display area.

For example, when the casting control is triggered, to prevent accidental touches, the casting control may switch to displaying “Swipe left to start casting” and display the name or icon of the application to be cast next to the button. Then, after confirming that the application casting operation has been triggered, the name and/or icon of the cast application may be displayed in opposite directions on the far left (the second position) and far right (the first position) of the control area, respectively.

At S304, in response to the activation operation acting on the switch control in the control area, the first display area of the display screen may be controlled to display the first display content, and the control area may be controlled to have display parameter(s) related to the first display content.

In some embodiments of the present disclosure, the electronic device may also, in response to the activation operation acting on the switch control in the control area, control the first display area of the display screen to display the first display content, and configure the control area to have display parameter(s) related to the first display content.

For example, in response to the on/off operation of the control area’s switch, the electronic device may turn on the first display area. At this time, the first display area may display a default wallpaper state. Simultaneously, the control area may display content related to the default wallpaper state. For example, the control area may extract colors from the default wallpaper’s dominant color tone to display a “solid color” image. The control area may also display according to user-defined display parameter(s), such as a “rainbow stripe” pattern.

At S305, the environmental data of the space environment in which the electronic device is located is monitored, and the display parameter(s) and/or display content of the control area are controlled based on the environmental data.

In some embodiments of the present disclosure, the electronic device may also monitor the environmental data of the space environment in which the electronic device may be located, and control the display parameter(s) and/or display content of the control area based on the environmental data.

In some embodiments of the present disclosure, the environmental data may include the positional relationship between the user and the electronic device. The environmental data may be acquired through components such as sensors built into the electronic device.

Exemplarily, the electronic device may acquire the current positional relationship between the user and the electronic device through a camera (a visual sensor). For example, the electronic device may confirm the distance between the user and the electronic device by acquiring images, and then determine whether to enable the control area based on the distance. Assuming the user may be currently far from the electronic device, the control area may be disabled. Then, when at a certain moment the distance between the user and the electronic device is determined to be within a usable distance, the control area may be enabled, and the size of the control area and the size or dimensions of the information displayed in the control area may be adjusted according to the current distance such that the user at the current distance may clearly see the content in the control area.

In the control method provided by the present disclosure, the electronic device, in response to the target trigger event, may control the control area provided at the display screen of the electronic device to be in an enabled or disabled state; or may control the control area to have the display parameter(s) and/or display content corresponding to the enabled or disabled state. In the enabled state, the control area may respond to the target control operation to control the display parameter(s) and/or display content of at least one display area on the display screen, where the control area may abut at least one of the display areas. Therefore, the display screen of the electronic device may display the control area at the position adjacent to at least one display area, and this control area may receive target control operations in the enabled state to control the display parameter(s) and/or content of at least one display area. In other words, based on the control area, efficient interaction between the electronic device and the user may be achieved, greatly enhancing the interactivity and intelligence of the electronic device.

Based on the above embodiments, another embodiment of the present disclosure provides an electronic device, which may be a laptop computer capable of supporting a “tri-fold” state. As shown in FIG. 19, the laptop computer may include a first body, a second body, and a third body, where the third body may be a keyboard component, and the first body and the second body may be flexible screens.

In some embodiments of the present disclosure, the hinge assembly used to achieve the folding effect in the laptop computer may have a built-in angle sensor. The angle sensor may upload the detected angle to the upper-layer application, which divides the laptop screen into two display areas according to the folding angle. Simultaneously, the hinge assembly may display a corresponding control area, which may provide the function of controlling the display of the two display areas.

As shown in FIG. 19, for this laptop computer, the B-screen area (the second display area of the second body) may be fully visible to the user and serve as the user’s work area. For the hinge area, the user on the keyboard side may see most of it, and the person sitting opposite the user may also see most of it, making this area a common operating area. The A-screen area (the first display area of the first body) may not be visible to the user on the keyboard side, but it may be visible to the person sitting opposite the user or someone interacting with the user.

In some embodiments of the present disclosure, the appearance and hiding of the control area may depend on two types of angles: the angle between the display screen B and the keyboard, and the angle between the display screen B and the display screen A. The angle between screen B and the keyboard, firstly, may need to be greater than a specified angle. This primarily considers whether the user on the keyboard side may see the display screen B. In a simple implementation, 45 degrees may be a suitable angle. This angle may also be dynamically set by the laptop camera after detecting the relative position of the user and the display screen. When the angle between the display screen B and the keyboard is larger than 45 degrees, the control area may be displayed between the display screen B and the display screen A. As for the angle between the display screen B and the display screen A, the viewing angle of the content on the display screen A from the user on the keyboard side may be primarily considered. In a simple implementation, the specified angle between the display screen B and the display screen A may be set to 120 degrees. This specified angle may also be dynamically set by the laptop camera after detecting the relative position of the user and the display screen.

In some embodiments of the present disclosure, the default maximum vertical height of the control area may be the product of the bending radius of the hinge area and π, i.e., the circumference of half a circle. Similarly, this height may be dynamically adjusted through settings, the purpose of which may be to allow users to better utilize the functions of the folded area after folding. For example, when the control area needs to display too many functions and cannot be fully displayed horizontally, its maximum vertical height may be increased.

In some embodiments of the present disclosure, the control area may appear directly when folded to a specified angle by default, or it may begin to “gradually appear” when folded to a specified angle. The gradual appearance may be a gradual change in shape, such as gradually growing outwards from the center, slowly transforming from a line into a complete control area, or gradually growing outwards from any side of the control area. The gradual appearance may also include a gradual change in transparency, such as from completely transparent to opaque; or a combination of both gradual shape and gradual transparency.

In some embodiments of the present disclosure, the default process for the appearance of the control area may be that the control area begins to appear after the control area is triggered and continues until the display screen A is completely folded (0 degrees) and fully displayed. The logic may be that the lower-level sensor transmits the angles between the display screen B and the display screen A to the upper-level application, which may then control the display, disappearance, expansion, or contraction of the control area based on the current angle. Of course, the timing of the complete display may be set and adjusted, which may be set to 10 degrees, 30 degrees, 45 degrees, etc., as long as it is larger than the trigger angle.

In some embodiments of the present disclosure, the control area may display a button to turn the display of the display screen A on and off (black screen). This button may be placed on the far left when facing the display screen B. When the button is turned off, the display screen A may not display, and the hinge area may display a black background with a starry sky and a comet moving through it. This state may have different designs, but its main purpose is to clearly show that the display screen A is in a black screen state with nothing being displayed.

In some embodiments of the present disclosure, when the button controlling the display on the display screen A is turned on, the display screen A may switch from a black screen to a display state, with its default state being a dedicated wallpaper state. Of course, this state may have different designs, such as a clock or some personalized display that does not involve personal privacy (user-defined photos, images, text, etc.). Simultaneously, the control area may enter a “rainbow bar” state, the color of which may be extracted from the dominant color tone of the display screen A or a fixed design color; and the main purpose may be to clearly demonstrate that the display screen A is displaying information.

In some embodiments of the present disclosure, when the button displayed in the display screen A is turned on, a “casting” button may appear on the far right of the control area (relative to the user on the keyboard). This button may be used to mirror the window selected by the user on the display screen B to the display screen A. This button may be very simple or have complex interactions. To address the issue of accidental touches, the default design may be that when the user touches the button, it switches to display “Swipe left to start casting” and the name of the content to be cast may be displayed next to the button. When the user lifts their finger, the button may return to its original position, and no casting action may occur. When the user swipes left, the window of the currently selected application may be cast to the display screen A.

In some embodiments of the present disclosure, after screen casting begins, the icons on both the left and right sides may change to the names or icons of the cast application. Simultaneously, the orientation of the application names or icons may differ on the two sides facing the control area. For example, one side may be upright and the other may be reversed, allowing the person facing the display screen A to easily identify the name of the cast application. Additionally, after screen casting begins, a message “You are screen casting” may be displayed in the center of the control area, along with a close button, allowing users on both sides to easily close the display screen casting. When either user clicks the close button, the display screen casting may end, and the display screen A may return to its basic wallpaper display state. Furthermore, since the camera may be positioned facing the user on the display screen A in the folded state, the display screen casting may be actively closed when it is detected that no one is on one side of the display screen A for a prolonged period. Whether this function may be enabled may also be set by the user.

In some embodiments of the present disclosure, when a laptop divides the display area into a first display area and a second display area, it may first declare an application-exclusive area to Windows to ensure that Windows will not move other applications into that area. Then, when the interface of the customized framework application is launched, its orientation may be set to vertically reversed, and the customized framework application may be moved into that area, thereby controlling the content displayed within the framework application. There may be two implementation schemes for controlling the content displayed within the framework application. One scheme may target the window that needs to be cast. For example, when an application is cast from the display screen B to the display screen A, the window on the display screen B that needs to be cast may be determined first, which is usually the active, top-mounted window. Then, the corresponding interface may be used to capture the window content, and the captured content may be re-displayed in a window within the customized framework application, which has already been set to vertically reversed. In some other embodiments, when the window is minimized on the display screen B, there may be two processing methods. One method may be to automatically select the next active window, capture it, and cast it onto the display screen A. The other method may be to bind the original application, but stop capturing and retain the last frame, or display a prompt message “This window has been minimized”. In some other embodiments, instead of capturing individual application windows, the entire screen of the display screen B may be captured and cast onto the display screen A. Since the first solution displays part or all of the content of the display screen B onto the display screen A in the absence of expanding the display screen, the present disclosure may also provide another solution to support screen expansion. First, a virtual screen may be created through a virtual display driver. Then, the entire desktop display content of the virtual display may be captured and displayed in the window of the customized framework application on the display screen A. This may provide the user with an additional monitor, and the user may drag and drop the content they want to display of this monitor onto the display screen A.

The present disclosure provides a laptop computer with a “tri-fold” form. A control area may be provided between the display areas of the first body and the second body of the laptop computer. This control area may remain hidden when there is no display or control requirement, but may be triggered to display when there is a display or control requirement, providing corresponding control or interactive functions. This may support various usage scenarios for the “tri-fold” form laptop, improving its operability and intelligence.

Furthermore, as shown in FIG. 25, the electronic device 0 may also include a processor 11 and a memory 12 storing instructions executable by the processor 11. Further, the electronic device 1 may also include a communication interface 13 and a bus 14 for connecting the processor 11, the memory 12, and the communication interface 13.

In the embodiments of the present disclosure, the processor 11 may be at least one of an application specific integrated circuit (ASIC), a digital signal processor (DSP), a digital signal processing device (DSPD), a programmable logic Device (PLD), a field programmable gate array (FPGA), a central processing unit (CPU), a controller, a microcontroller, or a microprocessor. It is understood that for different devices, the electronic device used to implement the above-mentioned processor function may also be other types, and the present disclosure does not specifically limit this. The electronic device 1 may also include a memory 12, which may be connected to the processor 11. The memory 12 may be used to store executable program code, which includes computer operation instructions. The memory 12 may include high-speed RAM memory and may also include non-volatile memory, such as at least two disk drives.

In the embodiments of the present disclosure, the bus 14 may be used to connect the communication interface 13, the processor 11, and the memory 12, to facilitate communication between these devices.

In some embodiments of the present disclosure, the memory 12 may be used to store instructions or data.

In some embodiments of the present disclosure, the processor 11 may be configured to, in response to a target trigger event, control the display screen of the electronic device to have a first display area, a second display area, and a control area disposed between the first and second display areas. The control area may, in response to a target control operation, control the display parameter(s) and/or display content of the first and/or second display areas.

In some embodiments of the present disclosure, the processor 11 may also be configured to, in response to a first target trigger event, enable the control area provided at the display screen of the electronic device. In the enabled state, the control area may, in response to a target control operation, control the display parameter(s) and/or display content of at least one display area on the display screen; and the control area may abut at least one of the display areas.

In some embodiments of the present disclosure, the processor 11 may also be used to control the control area on the display screen of the electronic device to be in an enabled or disabled state in response to a target trigger event; and to control the control area to have display parameter(s) and/or display content corresponding to the enabled or disabled state. In the enabled state, the control area may respond to the target control operation to control the display parameter(s) and/or display content of at least one display area on the display screen. The control area may abut at least one of the display areas.

The memory 12 may be a volatile memory, such as a random-access memory (RAM); or a non-volatile memory, such as a read-only memory (ROM), flash memory, a hard disk drive (HDD), or a solid-state drive (SSD); or a combination of the above types of memory, to provide instructions or data to the processor 11.

In some embodiments, the program instructions corresponding to the control method provided by various embodiments of the present disclosure may be stored on a storage medium such as an optical disc, hard disk, or USB flash drive. When the program instructions corresponding to the control method in the storage medium are read or executed by the processor, the electronic device may be configured to: in response to a target trigger event, control the display screen of the electronic device to have a first display area, a second display area, and a control area disposed between the first and second display areas. The control area may be capable of controlling the display parameter(s) and/or display content of the first and/or second display areas in response to a target control operation.

When the program instructions corresponding to the control method in the storage medium are read or executed by a processor, the electronic device may also be configured to: in response to a first target trigger event, control the control area provided at the display screen of the electronic device to be in the enabled state. In the enabled state, the control area may be capable of controlling the display parameter(s) and/or display content of at least one display area on the display screen in response to a target control operation, where the control area abuts at least one of the display areas.

When the program instructions corresponding to the control method in the storage medium are read or executed by a processor, the electronic device may be also configured to: in response to a target trigger event, controlling the control area on the display screen of the electronic device to be in an enabled or disabled state; or control the control area to have display parameter(s) and/or display content corresponding to the enabled or disabled state. In the enabled state, the control area may control the display parameter(s) and/or display content of at least one display area on the display screen in response to a target control operation, where the control area abuts at least one of the display areas.

The present disclosure provides an electronic device, including a device body and a display screen disposed at the device body. The display screen may include at least two display areas and a control area disposed outside the at least two display areas. The control area may be configured to control the display of at least one of the at least two display areas in response to a target control operation. Therefore, the display screen of the electronic device in the present disclosure may display a control area, which may be used to receive target control operations, thereby allowing the electronic device to control different display areas on the display screen by responding to the target control operations received by the control area, thus greatly improving the control convenience and display effect of partitioned displays.

The present disclosure provides an electronic device, including a device body and a display screen disposed at the device body. The display screen may include at least one display area and a control area abutting at least one of the display areas. The control area may be configured to have the enabled state and the disabled state. In the enabled state, the control area may respond to a target control operation to control the display parameter(s) and/or display content of at least one display area on the display screen; and/or, in the disabled state, the control area may be in any one of a screen-off state, a hidden state, or a prohibited state. Therefore, the display screen of the electronic device in the present disclosure may display a control area, which may have two states: the enabled state and the disabled state. Based on the control area in the enabled state, flexible control of the display areas may be achieved. When the display area does not need to be operated on, the control area may be in the disabled state where it is not displayed. This not only allows for flexible control of the display areas for partitioned display, improving the partitioned display effect of the display screen, but also allows the control area to be invoked in the absence of needing to operate the display areas, greatly enhancing the intelligence of the electronic device.

The present disclosure provides an electronic device, including a device body and a display screen disposed at the device body. The display screen may include at least one display area and a control area abutting at least one of the display areas. The control area is provided with target window content, which can respond to target control operations to control the display parameter(s) and/or display content of at least one display area on the display screen. Therefore, the display screen of the electronic device in this application can display a control area, which can be provided with target window content, enabling the control area to receive and respond to target control operations to control the display parameter(s) and/or display content of at least one display area. In other words, based on the control area, efficient interaction between the electronic device and the user can be achieved, greatly enhancing the interactivity and intelligence of the electronic device.

In the embodiments provided by the present disclosure, functional modules can be integrated into a single processing unit, or each unit can exist as a separate physical entity, or two or more units can be integrated into a single unit. One integrated unit can be implemented in hardware or as a software functional module.

In some embodiments, when the integrated units of this disclosure are implemented as software functional modules and sold or used as independent products, they may also be stored in a computer-readable storage medium. Based on this understanding, the technical solution of this disclosure, can be embodied in the form of a software product. This computer software product may be stored in a storage medium and include several instructions to cause a computer device (which may be a personal computer, server, or network device, etc.) or a processor to execute all or part of the methods described in the various embodiments of this disclosure. The aforementioned storage medium may include various media capable of storing program code, such as flash disks, portable hard disks, read-only memories (ROMs), random access memories (RAMs), magnetic disks, or optical disks.

Those skilled in the art may understand that embodiments of the present disclosure may be provided as methods, systems, or computer program products. Therefore, the present disclosure may be implemented as the form of hardware embodiments, software embodiments, or embodiments combining software and hardware aspects. Furthermore, the present disclosure may be implemented as the form of a computer program product embodied on one or more computer-usable storage media (including, but not limited to, disk storage or optical storage) storing computer-usable program code.

The present disclosure is described with reference to implementation flowcharts and/or block diagrams of methods, apparatus (systems), and computer program products according to embodiments of the present disclosure. It should be understood that each block of the flowcharts and/or block diagrams, and combinations thereof, can be implemented by computer program instructions. These computer program instructions may be provided to a processor of a general-purpose computer, special-purpose computer, embedded processor, or other programmable data processing apparatus to produce a machine, such that the instructions, which execute via the processor of the computer or other programmable data processing apparatus, implements the functions specified in one or more blocks of the flow charts and/or block diagram. These computer program instructions may also be stored in a computer-readable storage medium that can direct a computer or other programmable data processing apparatus to function in a particular manner, such that the instructions stored in the computer-readable storage medium produce an article of manufacture including instruction means that implement the functions specified in one or more flowcharts and/or one or more block diagrams. These computer program instructions may also be loaded onto a computer or other programmable data processing apparatus to cause a series of operational steps to be performed on the computer or other programmable apparatus to produce a computer-implemented process, such that the instructions, which execute on the computer or other programmable apparatus, provide steps for implementing the functions specified in one or more flowcharts and/or one or more block diagrams.

The embodiments of the present disclosure have been described above. However, these embodiments are merely illustrative and not intended to limit the scope of the present disclosure. Although various embodiments have been described above, this does not mean that the measures in the various embodiments cannot be used advantageously in combination. Various substitutions and modifications may be made by those skilled in the art in the absence of departing from the scope of the present disclosure, and all such substitutions and modifications should fall within the scope of the present disclosure.

What is claimed is:

1. A control method comprising:
in response to a target trigger event, controlling a control area provided at a display screen of an electronic device to be in an enabled state;
wherein:
in the enabled state, the control area is able to respond to a target control operation to control at least one of a display parameter or display content of one or more display areas on the display screen; and
the control area abuts at least one of the one or more display areas.

2. The method according to claim 1, wherein the target trigger event is triggered in response to at least one of:
detecting that the electronic device switches to a target device form;
obtaining target input data acting on the electronic device; or
detecting a change in usage information of the electronic device.

3. The method according to claim 1, wherein controlling the control area to be in the enabled state includes at least one of:
controlling the control area located at a specified position on the display screen to have at least one of a target display parameter or output target display content;
controlling one display area on the display screen of the electronic device matching the target trigger event to be configured as the control area; or
controlling an application to be in a target operation state and/or controlling an application window of the application to be displayed and output to the control area, the application being capable of responding to the target control operation to control the at least one of the display parameter or the display content of the at least one display area.

4. The method according to claim 1, wherein controlling the control area to be in the enabled state includes at least one of:
in response to detecting that the electronic device switches to a first device form, controlling the control area corresponding to a first hinge assembly of the electronic device to be in a display state and/or to output first window content, the first hinge assembly being capable of causing the display screen to change form, and in the first device form, the display screen having a first display screen form;
in response to detecting that the electronic device switches to a second device form, configuring one of the one or more display areas that corresponds to a second hinge assembly of the electronic device as the control area to output second window content, the second hinge assembly being capable of causing the display screen to change form, and in the second device form, the display screen having a second display screen form;
in response to obtaining target input data acting on the electronic device, controlling one of the one or more display areas that matches a source of the target input data to be configured as the control area for outputting third window content; or
in response to detecting that users of the electronic device change, controlling the control area corresponding to the first hinge assembly to output fourth window content.

5. The method according to claim 4, further comprising at least one of:
when the electronic device is in the first device form, controlling the display screen to have a first display area and a second display area disposed at opposite sides of the control area, an included angle between planes where the first display area and the second display area are located being within a first angle range, and an included angle between a plane where the second display area or the first display area is located and a supporting surface of the electronic device being within a second angle range;
when the electronic device is in the second device form, controlling the display screen to have the first display area, the second display area, and a third display area abutting the second display area, an included angle between planes where the second display area and the third display area are located being within a third angle range; or
controlling the control area to output corresponding window content in a target input method based on a form change parameter of the electronic device.

6. The method according to claim 1, wherein controlling the control area to be in the enabled state includes at least one of:
controlling the display screen to run target firmware to control a first display area at a specified position as the control area, the first display area being able to control at least one of a display parameter or display content of a second display area abutting the first display area; or
requesting a display resource or a control permission for the control area from an operating system of the electronic device based on screen information of the display screen and position information of the control area at the display screen, to configure the control area using the display resources and control permissions, to cause the control area to enter the enabled state.

7. The method according to claim 1,
wherein the target trigger event is a first target trigger event;
the method further comprising at least one of:
in response to receiving a second target trigger event, controlling the control area to switch from the enabled state to a disabled state; or
in response to an included angle between planes where a first display area and a second display area disposed at the display screen are located switching from a first angle to a second angle, controlling the control area to always be in the disabled state;
wherein, in the disabled state, the control area is in a screen-off state, a hidden state, or a prohibited state.

8. The method according to claim 7, wherein controlling the control area to switch from the enabled state to the disabled state includes at least one of:
in response to detecting that the electronic device switches to a third device form different from the first device form or different from the second device form, controlling the control area to switch to the screen-off state, the hidden state, or the prohibited state, in the third device form, an included angle between planes where the second display area and the third display area are located being within a first angle range, or an angle between a plane where the second display area is located and a body of the electronic device being within a second angle range, with the body being capable of supporting the display screen;
in response to obtaining target input data acting on the electronic device, controlling the control area to switch to the screen-off state, the hidden state, or the prohibited state; or
in response to detecting a change user of the electronic device, controlling the control area to switch to the screen-off state, the hidden state, or the prohibited state.

9. An electronic device comprising:
a device body; and
a display screen disposed at the device body and including:
one or more display areas; and
a control area abutting at least one of the one or more display areas and configured to have an enabled state or a disabled state, wherein:
in the enabled state, the control area is able to respond to a target control operation to control at least one of a display parameter or display content of at least one of the one or more display areas; and/or
in the disabled state, the control area is in a screen-off state, a hidden state, or a prohibited state.

10. The electronic device according to claim 9, wherein:
the device body includes a first body, a second body, a hinge assembly connecting the first body and the second body to enable relative rotation between the first body and the second body, and a third body rotatably connected to the second body, relative rotation between the first body, the second body, and the third body resulting in different device forms of the electronic device;
the one or more display areas include a first display area disposed at the first body and a second display area disposed at the second body; and
the control area is disposed corresponding to the hinge assembly and located between the first display area and the second display area.

11. The electronic device according to claim 10, wherein in one of the device forms, the control area is in a display state and outputs target window content, an included angle between the first body and the second body is within a first angle range, and an included angle between the second body and the third body is within a second angle range.

12. The electronic device according to claim 10, wherein in one of the device forms, the control area is in the screen-off state, the hidden state, or the prohibited state, and an included angle between the second body and the third body is within an angle range.

13. The electronic device according to claim 10, wherein:
the third body is provided with a third display area of the display screen or an input device of the electronic device.

14. The electronic device according to claim 10, further comprising:
a processor configured to control the control area to switch from the enabled state to the disabled state in response to the electronic device switching from a first device form to a second device form.

15. The electronic device according to claim 10, further comprising:
a processor configured to control the control area to always be in the disabled state in response to an included angle between the first body and the second body switching from a first angle to a second angle.

16. The electronic device according to claim 10, further comprising:
a processor configured to control the control area to output corresponding window content in a target input mode and/or to control an area parameter of the control area, based on a form change parameter of the electronic device.

17. A non-transitory computer-readable storage medium storing a computer program that, when executed by a processor of an electronic device, causes the electronic device to:
in response to a target trigger event, control a control area provided at a display screen of the electronic device to be in an enabled state;
wherein:
in the enabled state, the control area is able to respond to a target control operation to control at least one of a display parameter or display content of one or more display areas on the display screen; and
the control area abuts at least one of the one or more display areas.

18. The storage medium according to claim 17, wherein the target trigger event is triggered in response to at least one of:
detecting that the electronic device switches to a target device form;
obtaining target input data acting on the electronic device; or
detecting a change in usage information of the electronic device.

19. The storage medium according to claim 17, wherein the program, when executed by the processor, further causes the electronic device to, when controlling the control area to be in the enabled state, perform at least one of:
controlling the control area located at a specified position on the display screen to have at least one of a target display parameter or output target display content;
controlling one display area on the display screen of the electronic device matching the target trigger event to be configured as the control area; or
controlling an application to be in a target operation state and/or controlling an application window of the application to be displayed and output to the control area, the application being capable of responding to the target control operation to control the at least one of the display parameter or the display content of the at least one display area.

20. The storage medium according to claim 17, wherein the program, when executed by the processor, further causes the electronic device to, when controlling the control area to be in the enabled state, perform at least one of:
in response to detecting that the electronic device switches to a first device form, controlling the control area corresponding to a first hinge assembly of the electronic device to be in a display state and/or to output first window content, the first hinge assembly being capable of causing the display screen to change form, and in the first device form, the display screen having a first display screen form;
in response to detecting that the electronic device switches to a second device form, configuring one of the one or more display areas that corresponds to a second hinge assembly of the electronic device as the control area to output second window content, the second hinge assembly being capable of causing the display screen to change form, and in the second device form, the display screen having a second display screen form;
in response to obtaining target input data acting on the electronic device, controlling one of the one or more display areas that matches a source of the target input data to be configured as the control area for outputting third window content; or
in response to detecting that users of the electronic device change, controlling the control area corresponding to the first hinge assembly to output fourth window content.
